(19) United States
(12) Patent Application Publication
(10) Pub. No.: US 2017/0054803 A1
(43) Pub. Date: Feb. 23, 2017

(54) INFORMATION PROCESSING DEVICE, METHOD, AND SYSTEM

(71) Applicant: FUJITSU LIMITED, Kawasaki-shi (JP)

(72) Inventors: Takako KATO, Setagaya (JP); Yuji MORITA, Shinagawa (JP); Mikio ITO, Kawasaki (JP); Osamu KIMURA, Kawasaki (JP); Shigeyuki MIYAMOTO, Yokohama (JP)

(73) Assignee: FUJITSU LIMITED, Kawasaki-shi (JP)

(21) Appl. No.: 15/226,947

(22) Filed: Aug. 3, 2016

(30) Foreign Application Priority Data
Aug. 18, 2015 (JP) 2015-161182

(51) Int. Cl. H04L 29/08; H04L 12/26

(52) U.S. Cl. CPC H04L 67/1097; H04L 67/101; H04L 43/0852

(57) ABSTRACT

An information processing method that is executed by an information processing device which communicates with a plurality of data centers through a network, the information processing method includes transmitting a first request to each of the plurality of data centers, receiving a first response to the first request, from each of the plurality of data centers, acquiring latency in communication through the network, for each of the plurality of data centers, based on time from transmission of the first request to reception of the first response, selecting a first data center from among the plurality of data centers, based on the latency of each of the plurality of data centers, and transmitting a second request for providing a replica of data addressed to the first data center, to a second data center among the plurality of data centers, the second data center storing data regarding the information processing device.

### CROSS-REFERENCE TO RELATED APPLICATION

This application is based upon and claims the benefit of priority of the prior Japanese Patent Application No. 2015-161182, filed on Aug. 18, 2015, the entire contents of which are incorporated herein by reference.

### FIELD

The embodiments discussed herein are related to an information processing device and an information processing method.

### BACKGROUND

With the development of communication technology, it is common that the user accesses information stored in a server or the like which is disposed in a predetermined place, from a plurality of different places, by using an information terminal, depending on a situation. Further, cloud computing and migration technology allow the information stored in a data center to be moved to another data center, or a different device in the data center, according to a processing load or the like. In addition, desktop virtualization allows a client device to use a program and information that are executed and stored in a server, as if they were executed in the client device. The related art is disclosed in, for example, Japanese Laid-open Patent Publication No. 2011-3187 and Japanese Laid-open Patent Publication No. 2006-79386.

### SUMMARY

According to an aspect of the invention, an information processing method that is executed by an information processing device which communicates with a plurality of data centers through a network, the information processing method includes transmitting a first request to each of the plurality of data centers, receiving a first response to the first request, from each of the plurality of data centers, acquiring latency in communication through the network, for each of the plurality of data centers, based on time from transmission of the first request to reception of the first response, selecting a first data center from among the plurality of data centers, based on the latency of each of the plurality of data centers, and transmitting a second request for providing a replica of data addressed to the first data center, to a second data center among the plurality of data centers, the second data center storing data regarding the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing system according to Embodiment 1;

FIG. 2 is a diagram illustrating an example of a configuration of an information processing device according to Embodiment 1;

FIG. 3 is a diagram illustrating an example of a data structure of a latency check result according to Embodiment 1;

FIG. 4 is a diagram illustrating an example of a data structure of a data center list according to Embodiment 1;

FIG. 5 is a diagram illustrating an example of a configuration of a server according to Embodiment 1;

FIG. 6 is a flowchart illustrating an exemplary flow of an information processing method according to Embodiment 1;

FIG. 7 is a flowchart illustrating an exemplary flow of a data center list generation process according to Embodiment 1;

FIG. 8 is a flowchart illustrating an exemplary flow of a replica generation necessity determination process according to Embodiment 1;

FIG. 9 is a flowchart illustrating an exemplary flow of a replica generation process according to Embodiment 1;

FIG. 10 is a flowchart illustrating an exemplary flow of a connection process to a replica destination according to Embodiment 1;

FIG. 11 is a flowchart illustrating an exemplary flow of an end process according to Embodiment 1;

FIG. 12 is a diagram illustrating a hardware configuration of an information processing system according to Embodiment 2;

FIG. 13 is a diagram illustrating an example of a configuration of a client device according to Embodiment 2;

FIG. 14 is a diagram illustrating an example of a configuration of a server according to Embodiment 2;

FIG. 15 is a sequence chart illustrating an exemplary flow of a data center list generation process according to Embodiment 2;

FIG. 16 is a sequence chart illustrating an exemplary flow of a replica generation necessity determination process according to Embodiment 2;

FIG. 17 is a sequence chart illustrating an exemplary flow of a replica generation process according to Embodiment 2;

FIG. 18 is a sequence chart illustrating an exemplary flow of a connection process to a replica destination according to Embodiment 2;

FIG. 19 is a sequence chart illustrating an exemplary flow of an end process according to Embodiment 2;

FIG. 20 is a sequence chart illustrating an exemplary flow of a data center list generation and distribution process according to Modification Example 1 of Embodiment 2;

FIG. 21 is a sequence chart illustrating an exemplary flow of a replica destination changing process according to Modification Example 2 of Embodiment 2;

FIG. 22 is a sequence chart illustrating an exemplary flow of a re-connection process after replica generation according to Modification Example 3 of Embodiment 2; and

FIG. 23 is a diagram illustrating a computer that executes an information processing program.

### DESCRIPTION OF EMBODIMENTS

In a case where business data is stored in a server in a data center and is used, in a company, or the like, usually, it is considered that the user accesses the business data by using a predetermined information processing device, from the company. However, the user may access the business data by using a portable terminal or the like, from a place different from a normal access source, such as a business trip destination. In this case, a distance between the server in which the business data is stored and a point at which the mobile terminal is connected to a network is different from that at the normal business time. Therefore, it is considered that time used to acquire information becomes longer.

The technique disclosed in Embodiments has an object to suppress an increase in latency in one aspect.

Hereinafter, the embodiments of an information processing device, an information processing system, an information processing method, and an information processing program of the present disclosure will be described in detail with reference to the drawings. It is assumed that the present embodiments are applied to a data center system including a plurality of data centers which provide virtual machines. It is to be noted that the disclosure is not limited by the present embodiments. Respective embodiments can be combined as appropriate within a range in which processing contents are not contradicted.

### Embodiment 1

Configuration of information processing system according to Embodiment 1

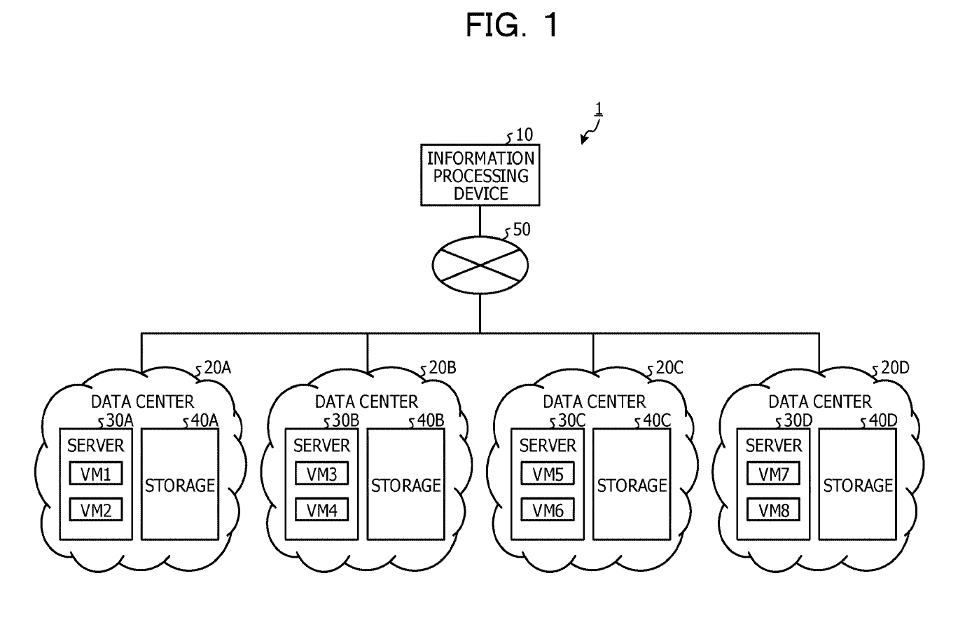

FIG. 1 is a diagram illustrating a hardware configuration of an information processing system according to Embodiment 1. As illustrated in FIG. 1, an information processing system 1 includes an information processing device 10, and data centers 20A, 20B, 20C, and 20D. Respective data centers 20A to 20D include servers 30A to 30D equipped with virtual machines (VM), and storages 40A to 40D. The data centers 20A to 20D are connected to the information processing device 10 through a network 50. The data centers 20A to 20D are connected to each other through the network 50. Virtual machines VM1, 2, VM3, 4, VM5, 6, and VM7, 8 are respectively generated in the servers 30A to 30D. Although four data centers are illustrated in FIG. 1, the number of data centers may be any number, insofar as the number is two or more. The numbers of servers and storages which are included in each data center are not limited, and each data center may include any number of servers and storages. In addition, the number of virtual machines included in servers is not limited. In Embodiment 1, it is assumed that data that is used by the information processing device 10 is stored in the data center 20A.

Configuration of Information Processing Device

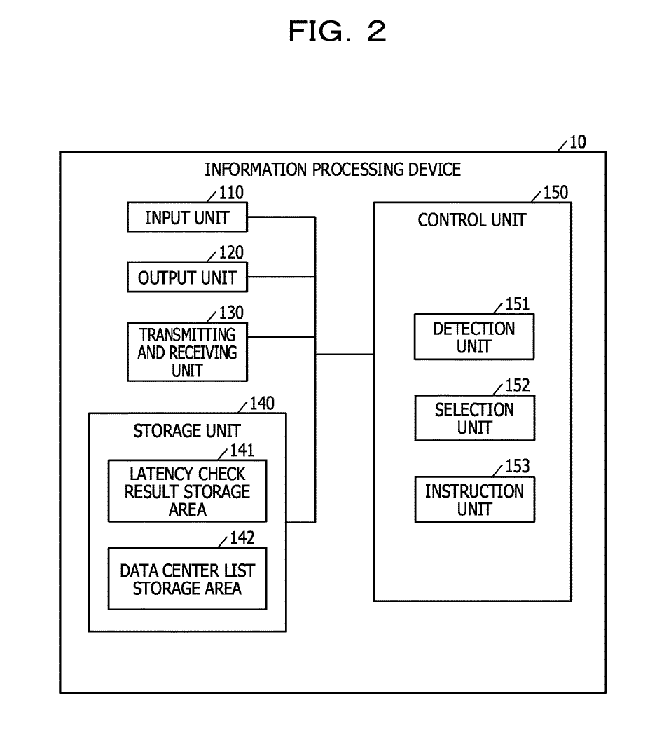

Next, a configuration of an information processing device 10 according to Embodiment 1 will be described. FIG. 2 is a diagram illustrating an example of a configuration of an information processing device according to Embodiment 1. The information processing device 10 is, for example, a personal computer (PC), a tablet PC, or the like.

As illustrated in FIG. 2, the information processing device 10 includes an input unit 110, an output unit 120, a transmitting and receiving unit 130, a storage unit 140, and a control unit 150.

The input unit 110 receives information. The input unit 110 is, for example, a keyboard, a mouse, a touch panel, or the like, and a circuit for receiving input signals transmitted therefrom.

The output unit 120 outputs information. The output unit 120 is, for example, a display screen, a speaker, or the like, and a circuit for processing signals to be output thereto. The output unit 120 outputs information such as speech, an image or other media, and generates a signal for outputting the information.

The transmitting and receiving unit 130 transmits and receives information through a network 50 to which the information processing device 10 is connected. The transmitting and receiving unit 130 receives, for example, information to be stored in the data center, from the data centers 20A to 20D. In addition, the transmitting and receiving unit 130 transmits, for example, an instruction such as a latency checking command (to be described later) to the data centers 20A to 20D.

The storage unit 140 is a storage device that stores various types of data. The storage unit 140 is, for example, a storage device such as a hard disk, a solid state drive (SSD), and an optical disk. Incidentally, the storage unit 140 may be a semiconductor memory capable of rewriting data, such as a random access memory (RAM), a flash memory, and a non-volatile static random access memory (NVSRAM).

The storage unit 140 stores an operating system (OS) and various programs that are executed by the control unit 150. The storage unit 140 stores various programs including, for example, a program executing a replica generation necessity determination process to be described later. Further, the storage unit 140 stores various types of data used in the program that is executed by the control unit 150. The storage unit 140 includes, for example, a latency check result storage area 141, and a data center list storage area 142.

The latency check result storage area 141 stores a latency check result which is a result obtained by the information processing device 10 checking the delay occurring in the communication with each of the data centers 20A to 20D. The latency checking is performed by the information processing device 10 transmitting latency checking commands to the servers 30A to 30D in the data centers 20A to 20D and receiving responses from the servers 30A to 30D. The latency check result includes, for example, information such as date and time when the information processing device 10 transmits the latency checking commands, and date and time when responses are received from the data centers. If the latency check result is capable of specifying the latency between the information processing device 10 and the data center, the form thereof is not particularly limited.

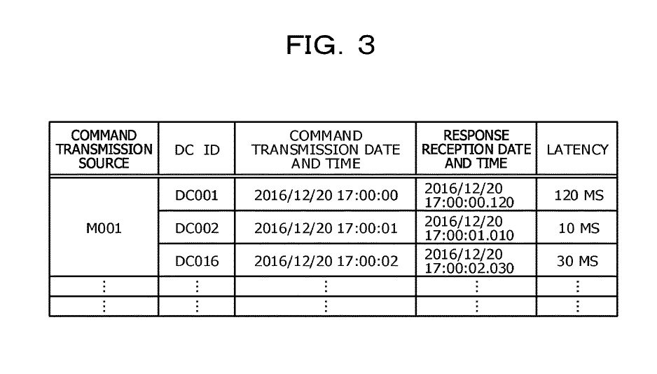

FIG. 3 is a diagram illustrating an example of a data structure of the latency check result according to Embodiment 1. In the example of FIG. 3, the latency check result includes “Command transmission source”, “DC ID”, “Command transmission date and time”, “Response reception date and time”, and “Latency”. “Command transmission source” is information for specifying the information processing device 10 that has transmitted the latency checking command. “Command transmission source” may be, for example, user identification information of the user of the information processing device 10. “DC ID” is an identifier for uniquely specifying a data center which is a transmission destination of the latency checking command. “Command transmission date and time” is information for specifying the date and time when the latency checking command is transmitted. “Response reception date and time” is information for specifying the date and time when the information processing device 10 receives the response that has been transmitted by the data center, in response to the latency checking command. “Latency” is delay occurring in communication with the data centers, which is calculated by transmitting the latency checking command and receiving the response.

For example, the example of FIG. 3 illustrates that the latency checking command is transmitted from the information processing device 10 specified by “Command transmission source, M001” to the data centers that are specified by DC IDs “DC001”, “DC002”, and “DC016”. The latency checking command addressed to the data center specified by “DC ID, DC001” is transmitted at 17:00:00 on Dec. 20, 2016. The response from the data center specified by “DC ID, DC001” is received at 17:00:00.120 on Dec. 20, 2016. The result of latency checking indicates that the calculated latency is “120 ms”.

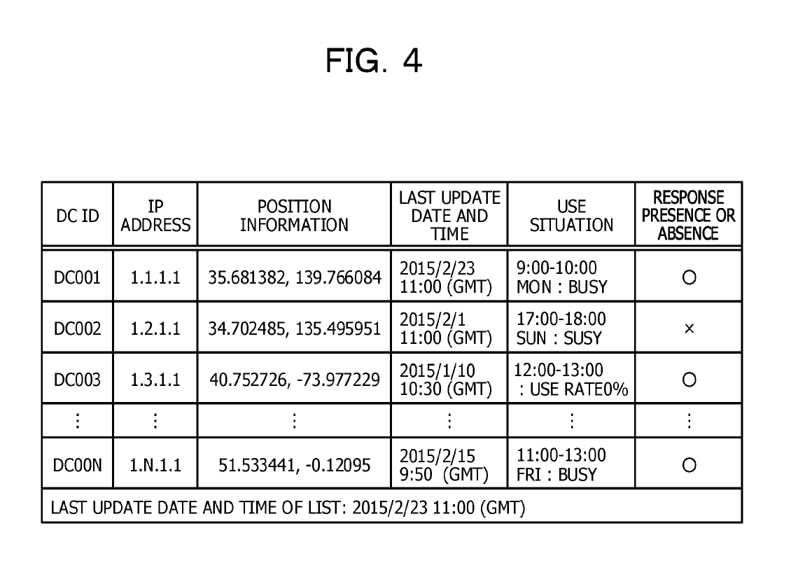

The data center list storage area 142 stores a data center list which is a list of data centers that are available by the information processing device 10. For example, the information processing device 10 acquires the data center list from the data center 20A. FIG. 4 is a diagram illustrating an example of a data structure of the data center list according to Embodiment 1. In the example of FIG. 4, the data center list includes “DC ID”, “IP address”, “Position information”, “Last update date and time”, “Use situation”, and “Response presence or absence”. “DC ID” is the same as “DC ID” included in the latency check result of FIG. 3. “IP address” is the IP address that uniquely specifies the data center. “IP address” is, for example, the IP address of the management server of the data center. In Embodiment 1, “IP address” is the IP addresses of the servers 30A to 30D which are disposed in the data centers 20A to 20D. “Position information” is information indicating the position of the data center. “Position information” is, for example, the latitude and longitude of the point where a data center is present. “Last update date and time” is a date and time when the information about the data center was last updated. The information that is included in the data center list is collected from each data center. Thus, the date and time when information was last updated in each data center is indicated as “Last update date and time”. “Use situation” indicates the use situation of each data center. “Use situation” indicates, for example, time of day and day of the week when each data center enters a busy state. “Response presence or absence” indicates whether or not there is a response when a request for requesting the transmission of the information indicating the use situation to the data center is transmitted. In addition, the data center list includes information about the latest update date and time of the data center list. For example, the data center list illustrated in the example of FIG. 4 includes information “List last update date and time: 2015/2/23 11:00 (GMT)” on the bottom. This indicates that the data center list was last updated at 11:00 (Greenwich mean time) on Feb. 23, 2015.

The servers 30A to 30D of the respective data centers 20A to 20D check and store the use situation of resources in the data centers in which the servers are disposed, at a predetermined timing. Then, the respective servers 30A to 30D transmit a request for requesting the transmission of information about the use situation to the server in another data center, at a predetermined timing. The respective servers 30A to 30D integrate the information obtained from other servers and generate a data center list in response to the request.

Returning back to FIG. 2, the control unit 150 is a device that controls the information processing device 10. For the control unit 150, an electronic circuit such as a central processing unit (CPU) and a micro processing unit (MPU), and an integrated circuit such as an application specific integrated circuit (ASIC) and a field programmable gate array (FPGA) can be adopted. The control unit 150 includes an internal memory that stores programs defining various processing procedures and control data, and executes various processes by using them. The control unit 150 functions as various processing units, by the various programs being operated. The control unit 150 includes, for example, a detection unit 151, a selection unit 152, and an instruction unit 153.

In the case of accessing the data center 20A and using the information, the information processing device 10 checks the latency in the communication to each of the data centers 20A to 20D which are available. The information processing device 10 performs the migration of data between the data centers, based on the check result of latency, and generates the replica of the data to be used in the data center having the lowest latency. The information processing device 10 performs the processing using the replica.

The detection unit 151 checks the latency in the communication with each of the data centers 20A to 20D. The detection unit 151 acquires information for detecting the latency. The detection unit 151 transmits, for example, latency checking commands to the servers 30A to 30D in the data centers 20A to 20D, and receives a response to the latency checking command. The detection unit 151 acquires, for example, information about the date and time when the latency checking command is transmitted to the server in each data center and the date and time when the response is received. Information for detecting the latency that the detection unit 151 has acquired is stored in the latency check result storage area 141.

The detection unit 151 detects the latency in the communication with each data center, based on the acquired information. The latency that the detection unit 151 has detected is stored in the latency check result storage area 141, in association with each data center.

The selection unit 152 compares latencies which are detected by the detection unit 151, and selects a data center having the lowest latency.

The instruction unit 153 transmits an instruction to dispose the replica of data in the selected data center, to the data center 20A that stores the data used by the information processing device 10.

Example of Configuration of Server

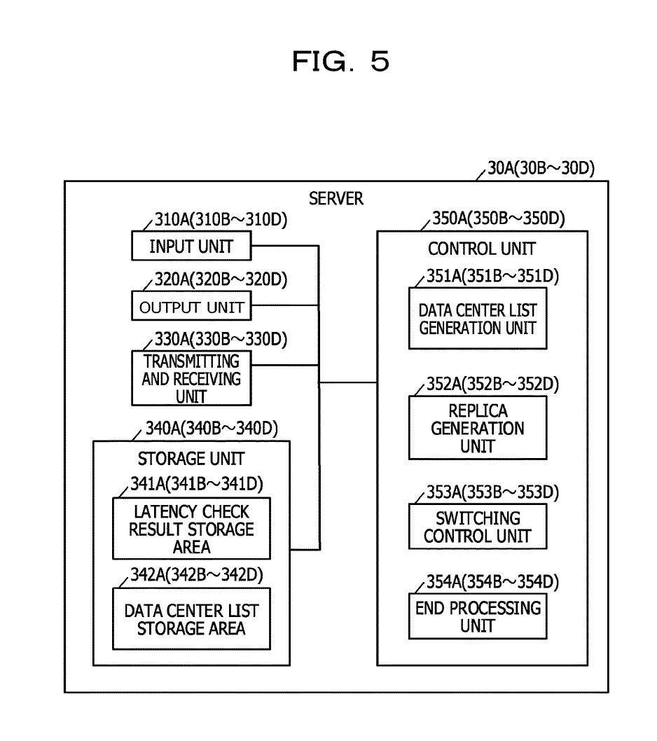

FIG. 5 is a diagram illustrating an example of the configuration of the server according to Embodiment 1. In the example of FIG. 5, the server 30A included in the data center 20A will be described as an example. Here, the configurations of the servers 30A to 30D included in the respective data center 20A to 20D are the same as each other.

As illustrated in FIG. 5, the server 30A includes an input unit 310A, an output unit 320A, a transmitting and receiving unit 330A, a storage unit 340A, and a control unit 350A.

The input unit 310A receives information. The input unit 310A is, for example, a keyboard, a mouse, a touch panel, or the like, and a circuit for receiving input signals transmitted therefrom.

The output unit 320A outputs information. The output unit 320A is, for example, a display screen, a speaker, or the like, and a circuit for processing signals to be output thereto. The output unit 320A outputs the information as speech, an image or other media, and generates a signal for outputting the information.

The transmitting and receiving unit 330A transmits and receives information through a network to which the server 30A is connected. The transmitting and receiving unit 330A receives, for example, a latency checking command from the information processing device 10, and transmits a response to the latency checking command. Further, the transmitting and receiving unit 330A transmits a request for requesting the transmission of information indicating the use situation of the data centers, to the servers 30B to 30D in other data centers 20B to 20D. The transmitting and receiving unit 330A receives the information indicating the use situation of each data center, from other data centers 20B to 20D.

The storage unit 340A is a storage device that stores various types of data. The storage unit 340A is, for example, a storage device such as a hard disk, a solid state drive (SSD), and an optical disk. Incidentally, the storage unit 340A may be a semiconductor memory capable of rewriting data, such as a random access memory (RAM), a flash memory, and a non-volatile static random access memory (NVSRAM).

The storage unit 340A stores an operating system (OS) and various programs that are executed by the control unit 350A. The storage unit 340A stores various programs including, for example, a program executing a replica generation process and an end process which are described later. Further, the storage unit 340A stores various types of data used in the program that is executed by the control unit 350A. The storage unit 340A includes, for example, a latency check result storage area 341A, and a data center list storage area 342A.

The latency check result storage area 341A stores the latency check result that is received from the information processing device 10. The structure of the information stored in the latency check result storage area 341A is the same as that illustrated in FIG. 3.

Information about the use situation of each data center is stored in the data center list storage area 342A. The configuration of the information stored in the data center list storage area 342A is the same as that illustrated in FIG. 4.

The control unit 350A is a device that controls the server 30A. For the control unit 350A, an electronic circuit such as a central processing unit (CPU) and a micro processing unit (MPU), and an integrated circuit such as an application specific integrated circuit (ASIC) and a field programmable gate array (FPGA) can be adopted. The control unit 350A includes an internal memory that stores programs defining various processing procedures and control data, and executes various processes by using them. The control unit 350A functions as various processing units, by the various programs being operated. The control unit 350A includes, for example, a data center list generation unit 351A, a replica generation unit 352A, a switching control unit 353A, and an end processing unit 354A.

In the following description, the servers 30B to 30D respectively include input units 310B to 310D, output units 320B to 320D, transmitting and receiving units 330B to 330D, storage units 340B to 340D, and control units 350B to 350D. The configuration of each unit is the same as that of the component included in the server 30A. Further, the storage units 340B to 340D of the servers 30B to 30D respectively include latency check result storage areas 341B to 341D, and data center list storage areas 342B to 342D. The configuration of each unit is the same as that of the server 30A. The control units 350B to 350D of the servers 30B to 30D respectively include data center list generation units 351B to 351D, replica generation units 352B to 352D, switching control units 353B to 353D, and end processing units 354B to 354D. The configuration and function of each unit are the same as those of the server 30A.

The data center list generation unit 351A acquires the information about the use situation of the data centers 20A to 20D. The data center list generation unit 351A transmits a request for transmitting the information about the use situation to the data centers 20B to 20D, for example, at a predetermined timing. The data center list generation unit 351A generates a data center list, based on the response to the request. Thus, the data center list generation unit 351A generates a list indicating the use situation of the data centers 20A to 20D included in the information processing system 1. The data center list that has been generated by the data center list generation unit 351A is stored in the data center list storage area 342A.

The replica generation unit 352A generates the replica of the data that is stored in the data center 20A, based on the instruction transmitted from the information processing device 10. Data of which the replica is to be generated may be stored in, for example, the server 30A, or the storage 40A. The replica generation unit 352A sets the priority of replica generation of data of a type being less affected by a latency such as streaming data to lower than the data of a type being highly affected by a latency. Whether or not data is streaming data may be determined based on the extension. Further, the replica generation unit 352A sets the priority of replica generation of the data having a high access frequency to higher than the data having low access frequency. Then, the replica generation unit 352A generates a replica in order according to the set priority.

The replica generation unit 352A transmits a generation request for the virtual machine to the server 30B of the data center 20B which is the replica destination, based on the instruction transmitted from the information processing device 10. If the generation completion notification of the virtual machine is received from the server 30B (replica generation unit 352B) of the replica destination, the replica generation unit 352A starts transmitting the data in the replica source. The replica generation unit 352A transmits the data of a type being less affected by a latency, such as streaming data, later than the data of a type being highly affected by a latency. Further, the replica generation unit 352A transmits the data having high access frequency first, and the data having low access frequency later, among data pieces of the replica source.

In addition, the replica generation unit 352A receives a generation request for a virtual machine for disposing the replica, from another data center, for example, the data center 20B (server 30B). The replica generation unit 352A generates a virtual machine in the data center 20A, based on the received generation request, and transmits the generation completion notification to the server 30B which is the transmission source of the generation request, if the generation is completed. In addition, after transmitting the generation completion notification, the replica generation unit 352A sequentially receives the data in the replica source that is transmitted from the transmission source server 30B of the generation request, and stores the data in the data center 20A. If the reception of the data in the replica source is started, the replica generation unit 352A transmits information of the connection destination for connection to the replica destination, to the server 30B which is the transmission source of the generation request for the virtual machine. Thereafter, the replica generation unit 352A continues receiving the data in the replica source in the background. Further, the replica generation unit 352A notifies the switching control unit 353A that the information of the connection destination is transmitted.

In a case of transmitting a generation request for the virtual machine for disposing the replica, the replica generation unit 352A transmits the information of the connection destination for connection to the replica destination which is received from the server of the replica destination, for example, the server 30B, to the information processing device 10. The information processing device 10 accesses the replica destination by using the received connection destination information.

The switching control unit 353A controls the access to the replica by the information processing device 10. For example, in a case where all pieces of the replica data are not yet stored in the replica destination, the switching control unit 353A causes the information processing device 10 to access the replica source through the replica destination.

After the replica of the data stored in the data center 20A is generated and is moved to another data center, the end processing unit 354A performs the end process to end the communication processing using the replica. The end processing unit 354A determines, for example, whether or not there is an access to the replica within a predetermined time. If it is determined that there is an access within a predetermined time, the end processing unit 354A ends the end process. Meanwhile, if it is determined that there is no access within a predetermined time, the end processing unit 354A transmits a difference between the data pieces of the replica destination and replica source, to the data center of replica source, and updates the data in the replica source. Thereafter, the virtual machine and data which have been generated as the replica destination are deleted. If the deletion is completed, the end processing unit 354A notifies the data center of the replica source of the fact. The end process is performed, for example, at a predetermined timing which is determined in advance, for example, at a predetermined time, once a day.

Exemplary Flow of Information Processing Method According to Embodiment 1

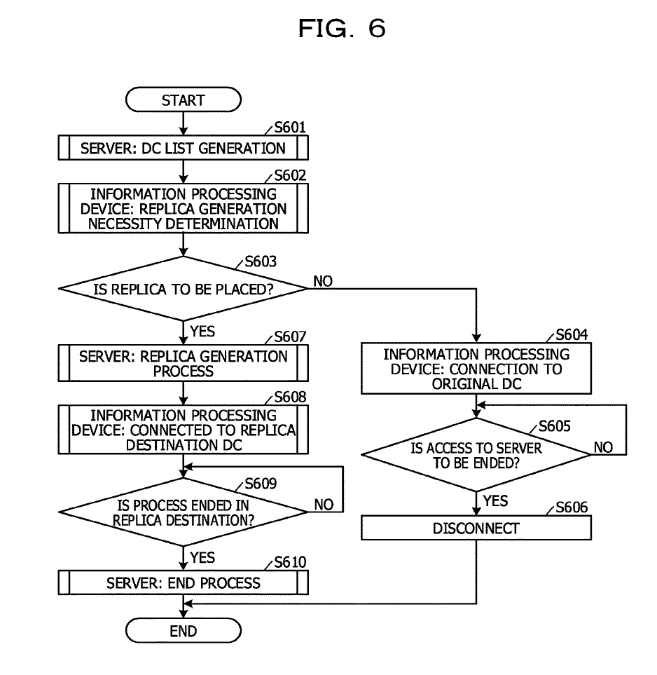

Next, a flow of information processing in the information processing system 1 according to Embodiment 1 will be described. FIG. 6 is a flowchart illustrating an exemplary flow of the information processing method according to Embodiment 1. FIG. 6 generally illustrates the flow of a process executed in the information processing system 1 of Embodiment 1.

First, the data center list generation unit 351A of the data center 20A acquires the information about the use situation of the respective data centers 20A to 20D, and generates a data center list (a DC list generation process, step S601). The information processing device 10 performs the latency checking for checking the latency of each data center, in order to use a data center having low latency. The information processing device 10 determines whether or not to place the replica of the data that is stored in the data center 20A in other data centers (a replica generation necessity determination process, step S602). As a result of the replica generation necessity determination process, in a case where it is determined not to place the replica (step S603, No), the information processing device 10 executes a process of connecting to the original DC, that is, the server 30A of the data center 20A (step S604). If the process is ended, and it is determined to end the access to the server 30A (step S605, Yes), the information processing device 10 executes a process of disconnecting the connection with the server 30A, and ends the process (step S606). Meanwhile, in a case where it is determined that the access to the server 30A is not ended (step S605, No), the information processing device 10 maintains the connection to the server 30A and continues the process.

As a result of the replica generation necessity determination process, in a case where it is determined to dispose the replica (step S603, Yes), the information processing device 10 transmits the replica generation request to the data center 20A. The replica generation process is performed between the data center 20A and the data center that is selected as the replica destination (replica generation process, step S607). If the connection destination information about the replica destination is received, the information processing device 10 is connected to the notified replica destination and performs a process (step S608). It is determined whether or not to end the process by the information processing device 10 in the replica destination (step S609). In a case where it is determined to end the process (step S609, Yes), after updating the data content so as not to cause inconsistency of data between the replica destination and the original DC, the end process of deleting the data in the replica destination is executed (step S610). Meanwhile, in a case where it is determined not to end the process (step S609, No), the replica is maintained as it is, and the determination of step S609 is repeated. Thus, the process by the information processing method according to Embodiment 1 is ended.

Exemplary Flow of Data Center List Generation Process

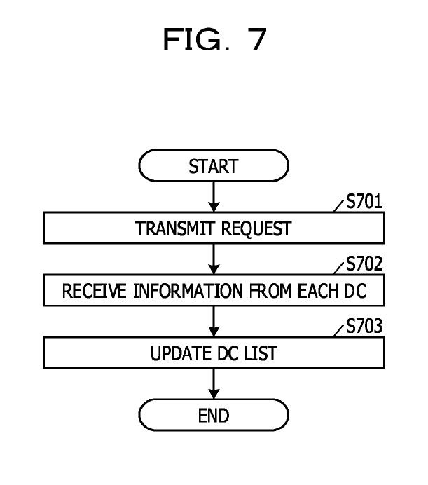

The data center list generation process indicated in step S601 of FIG. 6 will be described. FIG. 7 is a flowchart illustrating an exemplary flow of the data center list generation process according to Embodiment 1. In the example of FIG. 7, a case where the server 30A of the data center 20A performs a process will be described as an example.

First, the data center list generation unit 351A of the server 30A of the data center 20A collects the information about the use situation of the resources in the data center 20A. Further, the data center list generation unit 351A transmits a request for requesting the transmission of the information about the use situation, to other data centers 20B to 20D, at a predetermined timing (step S701). Then, the data center list generation unit 351A receives the information about the use situation from the respective data centers 20B to 20D (step S702). The data center list generation unit 351A updates data that is stored in the data center list storage area 342A, based on the information about the data center 20A and the received information (step S703). Through this, the data center list generation process is ended.

Exemplary Flow of Replica Generation Necessity Determination Process

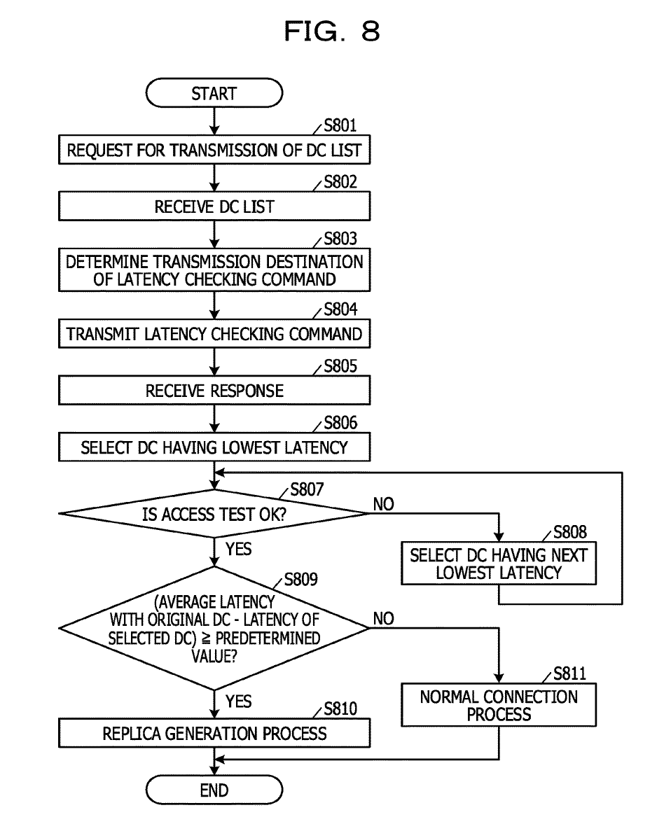

The replica generation necessity determination process indicated in step S602 of FIG. 6 will be described. FIG. 8 is a flowchart illustrating an exemplary flow of the replica generation necessity determination process according to Embodiment 1.

First, in a case of accessing the information that is in use in the information processing system 1, the information processing device 10 transmits a request for requesting the transmission of a data center list to the data center 20A (step S801). Here, it is assumed that the transmission destination of the request is set in advance for the information processing device 10 using the information processing system 1. For example, it is assumed that the data center 20A that stores the information used by the information processing device 10 is set in advance as the transmission destination of the request.

The information processing device 10 receives the data center list from the data center 20A (step S802). The received data center list is stored in the data center list storage area 142. The detection unit 151 determines a data center which is a latency check target, with reference to the data center list. In other words, the detection unit 151 determines the transmission destination of the latency checking command (step S803). The detection unit 151 determines the transmission destination of the latency checking command, based on, for example, a distance between the data center and the current position of the information processing device 10. For example, the detection unit 151 selects and determines a plurality of data centers which are close to the present position of the information processing device 10, as the transmission destination. For example, the detection unit 151 determines the transmission destination by comparing “Position information” included in the data center list with the current position that is measured by using the positioning function of the information processing device 10. The detection unit 151 may determine all the data centers included in the data center list, as the transmission destination.

Then, the detection unit 151 transmits the latency checking command to the determined transmission destination (step S804). The data center that has received the latency checking command transmits the response to the request, to the information processing device 10. The detection unit 151 receives the response (step S805), and updates the latency check result that is stored in the latency check result storage area 141. Further, the detection unit 151 detects the latency based on the acquired information, and updates the latency check result. Then, the selection unit 152 selects the data center having the lowest latency, based on the latency check result (step S806). The selection unit 152 selects the data center having the lowest latency from the data centers having low use rate, with reference, for example, the use situation of the data center list. The information processing device 10 performs an access test to access performing an experimental access, in order to check whether or not the selected data center is actually available (step S807). If the selection unit 152 selects a data center, for example, a command is transmitted from the transmitting and receiving unit 130 to the data center, and an access is attempted. If the access test fails (step S807, No), the selection unit 152 reselects a data center having the next lowest latency, with reference to the latency check result (step S808). The command is transmitted again from the transmitting and receiving unit 130, in response to the selection by the selection unit 152, and the access test is performed (step S807). If the access test is successful (step S807, Yes), the selection unit 152 determines whether or not a difference between the latency of the selected data center and an average value of the latencies with the original DC is a predetermined value or more (step S809). This determination is performed because in a case where a difference between latencies is not significant, there is a possibility that an improvement in processing speed due to replica generation is small but the latency is highly affected by the time used for the replica generation. If the difference between the latencies is determined to be the predetermined value or more (step S809, Yes), the selection unit 152 instructs the original DC to perform the replica generation process. Then, in the server 30A, the replica generation unit 352A performs a replica generation process (step S810). In contrast, in a case where the difference between the latencies is determined to be less than the predetermined value (step S809, No), the selection unit 152 does not instruct the replica generation process. The selection unit 152 notifies transmitting and receiving unit 130 that the data center is not selected, and the transmitting and receiving unit 130 starts a normal connection process by transmitting a connection request for the normal connection process, to the original DC (step S811). Here, the replica generation necessity determination process is ended.

Replica Generation Process

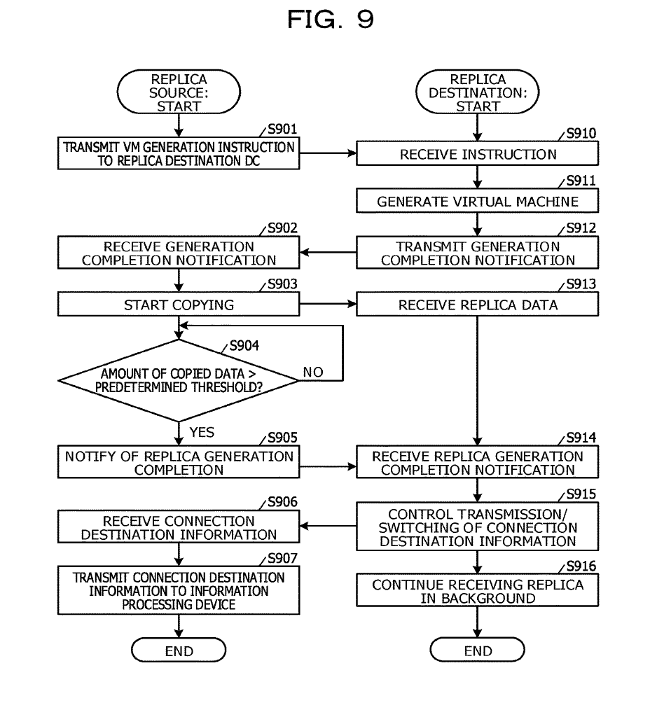

Next, the replica generation process indicated in step S607 of FIG. 6 will be described. FIG. 9 is a flowchart illustrating an exemplary flow of the replica generation process according to Embodiment 1. First, the process in the server of the replica source illustrated on the left side of FIG. 9 will be described. Here, the server of the replica source is assumed to be the server 30A.

First, the replica generation unit 352A of the data center 20A receives the replica generation request from the information processing device 10. The replica generation request includes information specifying a data center that is a replica destination that generates a replica, and a latency check result. The replica generation request may include position information of the information processing device 10. Here, it is assumed that the replica is generated in the data center 20B. The replica generation unit 352A transmits the generation instruction of the virtual machine to the server 30B of the replica destination data center 20B, based on the replica generation request (step S901). The replica generation unit 352B of the server 30B that has received the generation instruction generates the virtual machine, based on the instruction, and if the generation is completed, the replica generation unit 352B notifies the data center 20A of the fact. If the replica generation unit 352A of the data center 20A receives the generation completion notification (step S902), it starts copying the replica (step S903).

The replica generation unit 352A determines whether or not the amount of the copied data exceeds a predetermined threshold (step S904). In a case where it is determined that the amount is the predetermined threshold or less, the replica generation unit 352A continues copying as it is. In a case where it is determined that the amount exceeds the predetermined threshold, the replica generation unit 352A regards that the replica is completed, and sends a notification indicating the replica generation completion to the replica destination (step S905). In addition, the replica generation unit 352A receives connection destination information for accessing replica destination, from the replica destination (step S906). The replica generation unit 352A transmits the connection destination information of the replica destination to the information processing device 10 (step S907). As described above, the replica generation process in the replica source is ended.

The replica generation unit 352A continues copying the data in the background, even after the replica generation completion notification. However, at the time when the data of the amount exceeding the predetermined threshold is placed in the replica destination, the access from the information processing device 10 to the replica destination is allowed, and thus the processing speed as viewed from the user side is improved. In a case where the access destination data has not yet been placed in the replica destination, the access from the information processing device 10 is linked to the data in the original DC.

Further, the replica generation unit 352A preferentially generates the replica of the data having a high access degree, among data pieces of which the replicas are generated. The replica generation unit 352A sets the priority of replica generation of streaming data to low.

Next, the process in the server in the replica destination illustrated on the right side of FIG. 9 will be described. Here, the server of the replica destination is assumed to be the server 30B.

First, the replica generation unit 352B of the server 30B of the replica destination receives the generation instruction of the virtual machine (step S910). The replica generation unit 352B generates a virtual machine based on the instruction (step S911). The generation of the virtual machine is completed, and the replica generation unit 352B transmits generation completion notification to the replica source (step S912). The replica generation unit 352B starts receiving the replica data (step S913). The replica generation unit 352B receives the replica generation completion notification (step S914). If the replica generation completion notification is received, the replica generation unit 352B transmits the connection destination information for accessing the replica, to the replica source. Thereafter, the switching control unit 353B controls the access to the replica (step S915). Thereafter, the replica generation unit 352B continues receiving the replica in the background until all pieces of the replica data are received and stored (step S916). Then, if the reception of the replica is completed, the process is ended.

Exemplary Flow of Connection Process with Replica Destination

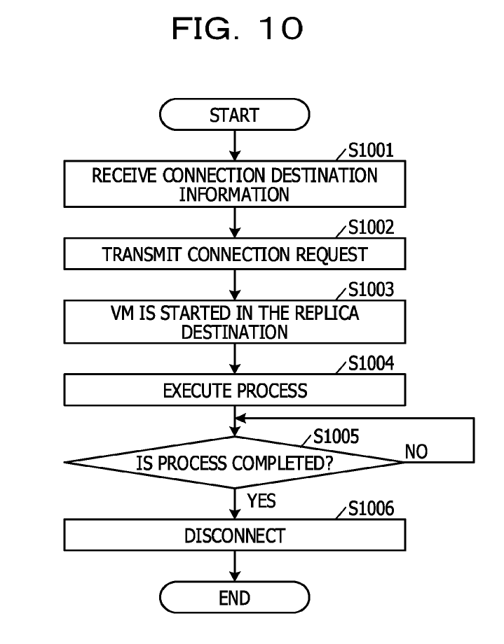

The connection process with the replica destination indicated in step S608 of FIG. 6 will be described. FIG. 10 is a flowchart illustrating an exemplary flow of the connection process with the replica destination according to Embodiment 1. Here, the data center 20B is assumed to be a replica destination.

The connection process with the replica destination is started after the replica generation unit 352A of the data center 20A of the replica source receives the connection destination information. First, if the replica generation unit 352A receives the connection destination information, the connection destination information of the replica destination is transmitted to the information processing device 10. The information processing device 10 that has received the connection destination information (step S1001) transmits a connection request to the data center 20B of the replica destination, based on the connection destination information (step S1002). In the data center 20B of the replica destination, the virtual machine is started, in response to the connection request of the information processing device 10, and the information processing device 10 is notified of the fact of the start (step S1003). The information processing device 10 accesses the virtual machine and executes the process (step S1004). Then, if the process is completed (step S1005, Yes), the connection is disconnected (step S1006). Until the process is completed (step S1005, No), the connection is maintained.

Exemplary Flow of End Process

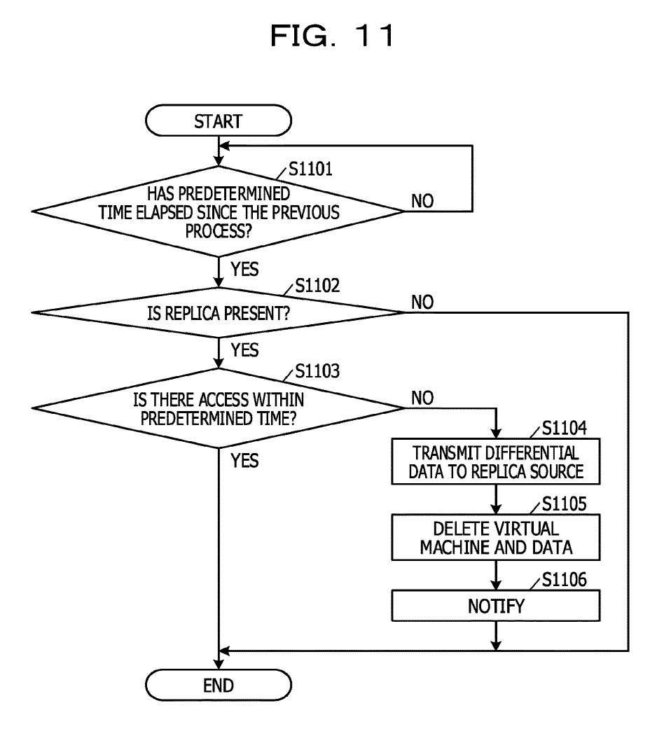

The end process illustrated in step S610 of FIG. 6 will be further described. FIG. 11 is a flowchart illustrating an exemplary flow of the end process according to Embodiment 1. Here, the data center 20A is assumed to be a replica source data center, and the data center 20B is assumed to be a replica destination data center.

In the data center 20B, the end processing unit 354B determines whether or not a predetermined time has elapsed since the previous end process (step S1101). If it is determined that the predetermined time has not elapsed (step S1101, No), the end processing unit 354B repeats the determination of step S1101. Meanwhile, if it is determined that the predetermined time has elapsed (step S1101, Yes), the end processing unit 354B determines whether or not a replica is present in the data center 20B (step S1102). In a case where there is no replica (step S1102, No), the end processing unit 354B ends the process. Meanwhile, in a case where it is determined that there a replica (step S1102, Yes), the end processing unit 354B determines whether or not there is an access to the replica within a predetermined time (step S1103). In a case where it is determined that there is an access within the predetermined time (step S1103, Yes), the end processing unit 354B ends the process. Meanwhile, in a case where it is determined that there is no access within the predetermined time (step S1103, No), the end processing unit 354B checks whether or not a difference occurring in the data in the replica destination is reflected in the replica source. In a case where the differential data is present, the end processing unit 354B transmits the differential data to the replica source and updates the data (step S1104). The end processing unit 354B deletes the virtual machine and the data that are generated for the replica in the data center 20B (step S1105). If the deletion is completed, the end processing unit 354B notifies the data center 20A of the replica source of the fact (step S1106). Thus, the end process is completed.

### Modification Example 1

### Limit in Latency Check Execution

In the embodiment described above, a scene where a replica necessity determination process is executed is not particularly limited. The information processing device 10 may execute the replica generation necessity determination process at the time of start-up. In addition, the information processing device 10 may be configured to check the latency with the data center 20A at the time of start-up. The information processing device 10 may be configured to execute the replica generation necessity determination process illustrated in FIG. 8, only in a case where the latency from the data center 20A exceeds the predetermined threshold. For example, the information processing device 10 may be configured such that the detection unit 151 automatically starts the replica generation necessity determination process illustrated in FIG. 8, in a case where a predetermined time has elapsed after a login screen is displayed after accessing the data center 20A.

### Modification Example 2

### Timing to Lock Data

In the embodiment described above, the data in the replica destination is assumed to be removed at the time of the end process. Without being limited thereto, a configuration is possible in which the replica destination is locked for a predetermined period, after the data in the replica source is unlocked and a difference is reflected. A configuration is possible in which the data in the replica destination may be deleted, after the consistency between the data in the replica source and the data in the replica destination is checked.

### Modification Example 3

### End Process Based on Specification of Location of Information Processing Device

In the embodiment described above, the end process is assumed to be executed in a case where there is no access to the replica for a predetermined time. Without being limited thereto, the end process may be executed in a case where there is an access to the replica from a remote location.

For example, the information processing device 10 is configured to necessarily transmit the position information in a case where the information processing device 10 accesses the data centers 20A to 20D. When the information processing device 10 accesses the data center 20A, the server 30A calculates the distance between the information processing device 10 and the data center 20A, based on the received position information. The data center 20A determines whether or not the replica is generated for the information that is designated as an access destination by the information processing device 10. Further, the data center 20A determines whether or not the distance between the information processing device 10 and the data center having the replica exceeds the predetermined threshold. In a case where the distance is determined to exceed the predetermined threshold, the data center 20A starts the end process.

With this configuration, in a case where the user of the information processing device 10 moves, it is possible to perform the information processing while suppressing an increase in the latency by appropriately moving the replica.

In addition, during the end process, the differential data may be reflected, after locking the data in the replica destination. Then, after checking that the data in the replica source has been updated, the data in the replica destination may be unlocked and deleted.

### Effects of Embodiment 1

The information processing system according to Embodiment 1 configured as described above includes a server that is disposed in one data center among a plurality of data centers and stores predetermined data. In addition, the information processing system includes an information processing device that is communicatively connected to the server through the network. The information processing device is provided with the selection unit and the instruction unit. The selection unit selects one data center out of the plurality of data centers, based on the latency in the communication with each of the plurality of data centers, which is detected from the response to the request that is sent to each of the plurality of data centers. Then, the instruction unit transmits an instruction to generate the replica of a predetermined type of data in the selected data center, to the server which is disposed in one data center. The server is provided with the replica generation unit that generates a replica, in response to the instruction from the instruction unit. In addition, the replica generation unit transmits the generated replica to the data center that the selection unit selects. Therefore, it is possible to suppress an increase in latency. For example, in a case where the user accesses the information stored in the cloud server by using the information processing device, it is possible to suppress a reduction in the processing speed due to the change of the point to be accessed. Further, it is possible to improve the processing speed in a case of being viewed from the user, by adjusting the storage location of the data, based on the latency. Accordingly, even at locations remote from the server of the replica source, it is possible to realize a rapid process, without feeling influence of the distance.

In addition, in the information processing system according to Embodiment 1, the selection unit selects the data center having the lowest latency. Therefore, in a case where the user accesses the information stored in the cloud server by using the information processing device, it is possible to suppress an increase in the latency due to the change of the point to be accessed. Further, it is possible to improve the processing speed in a case of being viewed from the user, by adjusting the storage location of the data based on the latency. Accordingly, even at locations remote from the server of the replica source, it is possible for the user to realize a rapid process, without feeling the influence of the distance.

Further, in the information processing system according to Embodiment 1, the selection unit selects the data center of which latency is the lowest, among data centers having a low use rate, based on the information about the use situation of each of the plurality of data centers. Therefore, it is possible to select the data center having a low latency while taking into account the use situation of the data center, and improve the processing efficiency as viewed from the user.

Further, in the information processing system according to Embodiment 1, in a case where a difference between the latency of one data center and the latency of the data center that stores predetermined data is a predetermined value or more, the selection unit selects one data center. Therefore, it is possible to generate a replica, excluding the case where an improvement in the processing efficiency due to generation of the replica of the data may not be expected, and it is possible to improve the processing efficiency as viewed from the user.

Further, in the information processing system according to Embodiment 1, the server is provided with the replica generation unit that generates the replica in response to an instruction from the instruction unit of the information processing device, and transmits the generated replica to the data center that the selection unit selects. Further, in the information processing system according to Embodiment 1, the replica generation unit included in the server transmits the replica to the data center that the selection unit selects, in order from the file having a high access frequency. Therefore, it is possible to first generate the replica of the data that is likely to be accessed by the user, and it is possible to improve the processing efficiency when viewed from the user.

In addition, the replica generation unit according to Embodiment 1 transmits the information for connection to the replica that is generated in the selected data center, to the information processing device, before the completion of the transmission of the replica. Further, the replica generation unit also continues transmitting the replica in the background, after the information processing device starts the connection to the replica. Therefore, the user of the information processing device utilizing the replica can smoothly perform the information processing without feeling the delay in the processing speed due to the generation of the replica.

Further, in the information processing system according to Embodiment 1, the server further includes a generation unit that acquires, from the data centers other than one data center among the plurality of data centers, the information about the use situation of the data centers, and generates a data center list. The selection unit included in the information processing device acquires the information about the use situation of the data centers from the server, and selects one data center based on the information and the latency. Therefore, the information processing device can select the data center based on the information about the use situation, after acquiring appropriate information about the use situation of the data center. Therefore, it is possible to realize the selection of data center adapted to a change in the situation.

Further, in the information processing system according to Embodiment 1, in a case where it is determined that it is not possible to generate a replica in a data center that is designated by the information processing device, the replica generation unit of the server selects another data center as a replica destination. The replica generation unit selects, for example, one of the data centers which are included in the data center list, other than the data center selected by the selection unit of the information processing device, as the replica destination. Therefore, after the information processing device selects the replica destination, even in a case where the selected replica destination can no longer be used due to some circumstances, it is possible to continue the process by quickly re-selecting the replica destination.

Further, in the information processing system according to Embodiment 1, in a case where there is no access to the replica for a predetermined period of time after the generation of a replica, the server further includes an end processing unit that removes the replica. Therefore, in a case where the replica that was generated is no longer used since the user of the information processing device moves, it is possible to resume the use of the data in the replica source by quickly deleting the replica.

### Embodiment 2

### Example of Configuration of Information Processing System According to Embodiment 2

The information processing system described as Embodiment 1 can be applied to various systems. For example, insofar as business data is stored in a predetermined server, the user usually accesses the business data from the vicinity of the server, and the user may access it from a remote site such as in business trip or the like, in a system, the embodiment can be applied to any system. The above embodiment can be applied to, for example, the case of accessing a remote file system, or using a virtual desktop infrastructure (VDI). Therefore, a description will be given about Embodiment 2 as the case of using the VDI.

Example of Configuration of Information Processing System of Embodiment 2

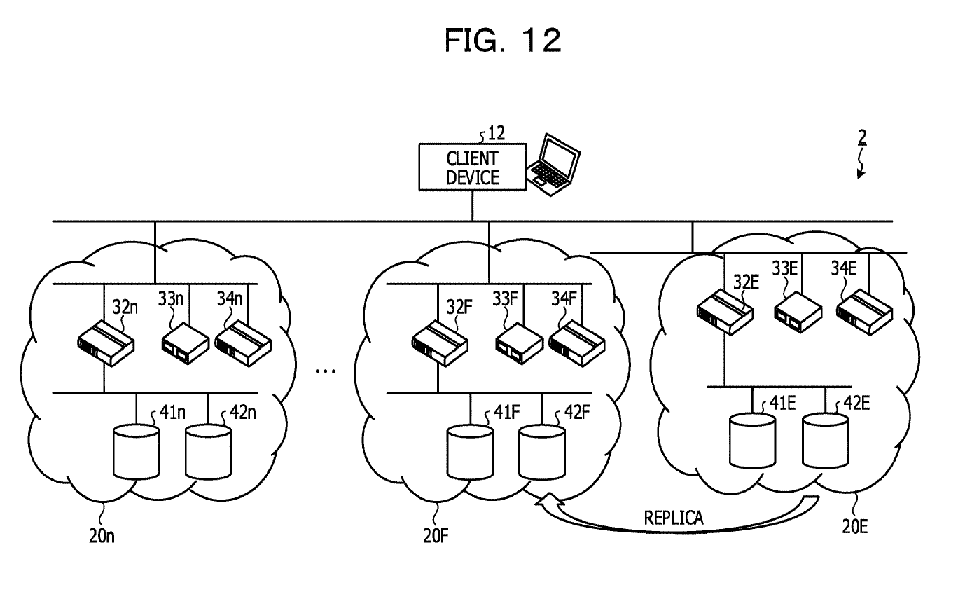

FIG. 12 is a diagram illustrating a hardware configuration of an information processing system according to Embodiment 2. The information processing system 2 according to Embodiment 2 includes a client device 12 such as a tablet PC and a note PC, and a plurality of data centers 20E, 20F, . . . , 20n which are connected to the client device 12 through a network. The data center 20E includes a server 32E, a connection broker server 33E, a virtual host server 34E, storages 41E and 42E. The data center 20F includes a server 32F, a connection broker server 33F, a virtual host server 34F, and storages 41F and 42F. The data center 20n includes a server 32n, a connection broker server 33n, a virtual host server 34n, storages 41n and 42n.

In the information processing system 2 according to Embodiment 2, the client device 12 executes a process using a virtual desktop, by using the data centers 20E to 20n. In order to realize the virtual desktop, a Web access function and an authentication server function are implanted in the servers 32E to 32n of the data centers 20E to 20n. Further, the data centers 20E to 20n are provided with the connection broker servers 33E to 33n. The servers 32E to 32n of the data centers 20E to 20n connect the client device 12 to the virtual machines that are executed in the virtual host servers 34E to 34n using remote desktop connection, by using the Web access function. In addition, the data that is used by the virtual host servers 34E to 34n is stored in the storages 41E to 41n.

Example of Configuration of Client Device

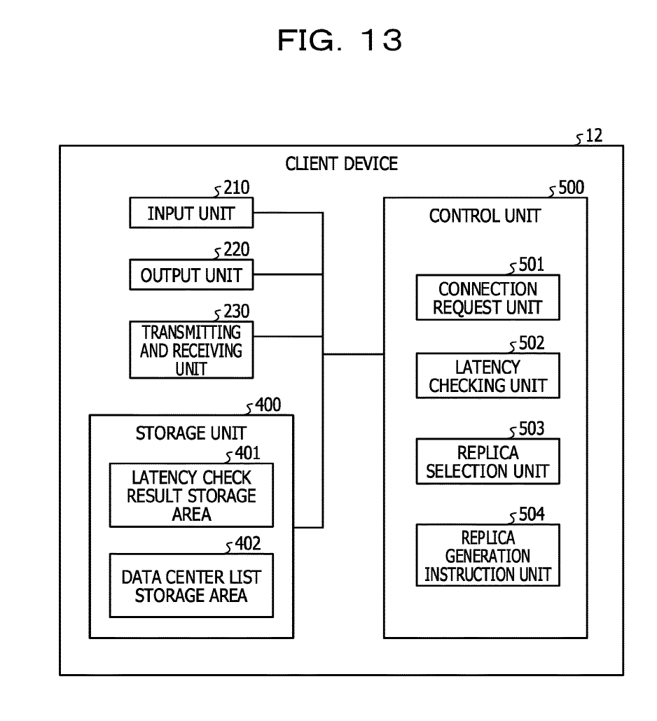

FIG. 13 is a diagram illustrating an example of the configuration of the client device according to Embodiment 2. The client device 12 includes an input unit 210, an output unit 220, and a transmitting and receiving unit 230. The client device 12 includes a storage unit 400, and a control unit 500. The configurations and the functions of the input unit 210, the output unit 220, and the transmitting and receiving unit 230 are the same as those of the input unit 110, the output unit 120, and the transmitting and receiving unit 130 of the information processing device 10 of Embodiment 1.

The storage unit 400 includes a latency check result storage area 401, and a data center list storage area 402. The storage unit 400, the latency check result storage area 401, and the data center list storage area 402 respectively have the same configurations and functions as those of the storage unit 140, the latency check result storage area 141, and the data center list storage area 142 of Embodiment 1.

The control unit 500 includes a connection request unit 501, a latency checking unit 502, a replica selection unit 503, and a replica generation instruction unit 504.

The connection request unit 501 transmits a connection request for requesting a connection in order to access and execute a predetermined process, to the data center that is included in the information processing system 2.

The latency checking unit 502 is a detection unit that executes the latency checking process and detects a latency, when receiving the latency check request. The latency check request includes a data center list which is a list of data centers which are available by the client device 12. The latency checking process is a process to check the latency in communication between the client device 12 and each data center.

If the latency check request is received, the latency checking unit 502 selects a data center which is a latency check target, with reference to the data center list that is included in the latency check request. The latency checking unit 502 may use all of the data centers that are included in the data center list as the latency check target. Furthermore, the latency checking unit 502 may select the data center that is running as the latency check target, based on the information included in the data center list. Furthermore, the latency checking unit 502 may select a data center list in which the current time does not belong to the time zone of which the use situation is busy, based on the information included in the data center list.

The latency checking unit 502 transmits the latency checking command to the selected data center. The latency checking unit 502 receives a response to the latency checking command, from each data center. The latency checking unit 502 calculates the latency in communication with each data center, based on the latency checking command and the response to the latency checking command. The calculated latency is stored in the latency check result storage area 401.

The replica selection unit 503 selects the data center having the lowest latency as the replica destination that generates a replica, based on the latency that the latency checking unit 502 calculates. If the replica destination is selected, the replica selection unit 503 transmits an access checking command to the replica destination. The replica selection unit 503 selects the data center for which there is a response to the access checking command as a replica destination. In a case where the response to the access checking command is not received within a predetermined time, the replica selection unit 503 selects the data center having the next lowest latency. The replica selection unit 503 repeats the transmission process of the access checking command. The replica selection unit 503 selects the data center which has received the response to the access checking command within a predetermined time, as the replica destination.

Next, the replica selection unit 503 compares the latency of the data center, for example, the latency of the data center 20E that stores the data that the client device 12 attempts an access, with the latency of the selected data center. In a case where the difference between the latency of the data center 20E and the latency of the selected data center is less than a predetermined value, the replica selection unit 503 determines not to execute the replica generation process. The replica selection unit 503 notifies the replica generation instruction unit 504 that the replica generation instruction is not to be made. In contrast, in a case where the difference between the latency of the data center 20E and the latency of the selected data center is a predetermined value or more, the replica selection unit 503 determines to execute the replica generation process. The replica selection unit 503 notifies the replica generation instruction unit 504 that the replica generation instruction is to be made. The notification includes information about the data center of the replica destination.

The replica generation instruction unit 504 transmits the replica generation instruction to the server 32E, based on the instruction from the replica selection unit 503. Further, the replica generation instruction unit 504 transmits a normal connection instruction to the server 32E, based on the instruction from the replica selection unit 503. In a case of receiving the notification indicating that the replica generation instruction is to be made, from the replica selection unit 503, the replica generation instruction unit 504 transmits the replica generation instruction to the server 32E. The replica generation instruction includes information about the data center of the replica destination. In a case of receiving the notification indicating that the replica generation instruction is not to be made, from the replica selection unit 503, the replica generation instruction unit 504 transmits a normal connection instruction to the server 32E.

After the replica generation instruction unit 504 transmits the replica generation instruction to the server 32E, if the connection destination information is received from the server 32E, the connection request unit 501 is connected to the replica destination, based on the connection destination information.

Example of Configuration of Server

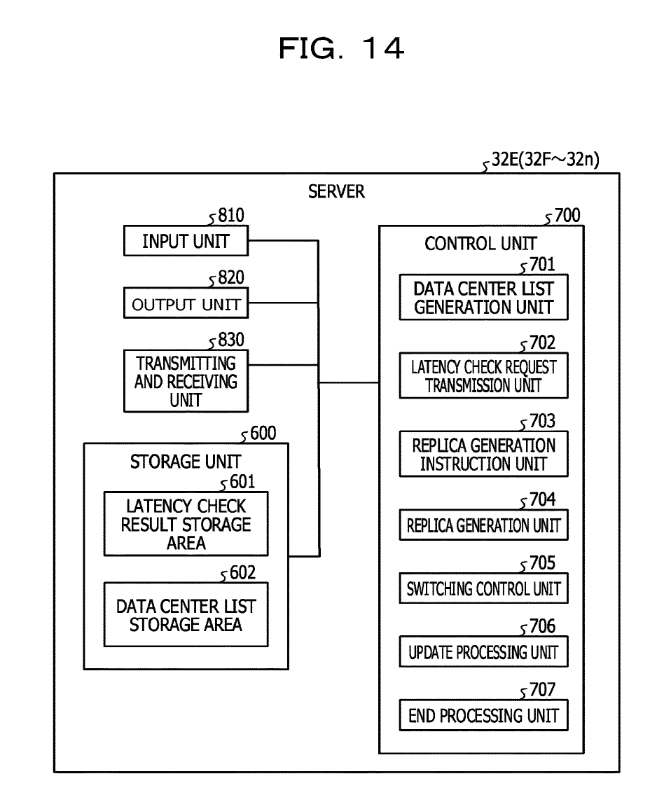

FIG. 14 is a diagram illustrating an example of the configuration of the server according to Embodiment 2. Next, an example of the configuration of the server 32E will be described. The server 32E includes an input unit 810, an output unit 820, a transmitting and receiving unit 830, a storage unit 600, and a control unit 700. Further, the servers 32F to 32n have the same configurations and functions of those of the server 32E. Hereinafter, a description will be made with the server 32E as an example.

The input unit 810, the output unit 820, and the transmitting and receiving unit 830 have the same configurations and functions as those of the input unit 310A, the output unit 320A, and the transmitting and receiving unit 330A of Embodiment 1.

The storage unit 600 includes a latency check result storage area 601 and a data center list storage area 602. The storage unit 600, the latency check result storage area 601, the data center list storage area 602 respectively have the same configurations and functions as those of the storage unit 340A, the latency check result storage area 341A, and the data center list storage area 342A of Embodiment 1.

The control unit 700 includes a data center list generation unit 701, a latency check request transmission unit 702, a replica generation instruction unit 703, a replica generation unit 704, a switching control unit 705, an update processing unit 706, and an end processing unit 707.

The data center list generation unit 701 generates a data center list. The data center list is a list of data centers that are included in the information processing system 2. The data center list generation unit 701 collects the information about the use situation of the resources in the data center 20E, at a predetermined timing. In addition, there is no particular limitation on the collection method of the information about the use situation of the resources in the data center 20E.

Further, the data center list generation unit 701 transmits a data center list transmission request to another data center in the information processing system 2, at a predetermined timing. The data center list generation unit 701 receives a response to the data center list transmission request. The data center list generation unit 701 updates the data center list that is stored in the data center list storage area 602, based on the received response.

If the data center list transmission request is received from another data center, the data center list generation unit 701 transmits the information about the use situation of the resources in the data center 20E as a response.

In a case where a connection request is transmitted from the client device 12, the latency check request transmission unit 702 receives the connection destination information notification that has been transmitted from the connection broker server 33E. The latency check request transmission unit 702 hooks, for example, the connection destination information notification. The latency check request transmission unit 702 holds the connection destination information notification, and transmits the latency check request to the client device 12. As described above, the latency check request includes a data center list which is the list of data centers which are available by the client device 12. The latency check request transmission unit 702 reads the data center list that is stored in the data center list storage area 602, and transmits a latency check request including the read data center list to the client device 12.

When the connection destination information notification is received, it is assumed that the latency check request transmission unit 702 may transmit an instruction of data center list update to the data center list generation unit 701, and data center list generation unit 701 may update the data center list. It is assumed that the latency check request transmission unit 702 may transmit the updated data center list.

If the replica generation instruction is received from the client device 12, the replica generation instruction unit 703 generates the replica of the data that is specified by the replica generation instruction. Since the generated replica is copied to the data center that is specified by the replica generation instruction, the replica generation instruction unit 703 transmits the replica preparation instruction to the server of the data center.

After the transmission of the replica preparation instruction, the generation completion notification of the virtual machine is received from the server of the transmission destination, the replica generation instruction unit 703 starts the transmission of the generated replica data. The transmission of the replica data is started before the generation of the replica is completed. For example, in a case where the data of which the replica is to be generated includes data having a high access frequency and data having a low access frequency, the replica generation instruction unit 703 starts the replica generation from the data having a high access frequency. The replica generation instruction unit 703 starts the transmission of the generated replica data from the data having a high access frequency. The replica generation instruction unit 703 performs the replica generation of the streaming data later than other pieces of data. This is because the streaming data is not considered to give a significant influence on the process of the client device 12, even if the latency is delayed.

If the transmission of the replica data is started, the replica generation instruction unit 703 transmits the replica generation completion notification to the server of the replica destination. The replica generation instruction unit 703 transmits the connection destination information for connection to the replica destination, to the client device 12. In addition, the replica generation instruction unit 703 makes the data in the replica source be in an inaccessible state so as not to be accessed. In other words, the replica generation instruction unit 703 locks the data.

In a case of receiving the replica preparation instruction, the replica generation unit 704 generates a virtual machine of the capacity specified by the replica preparation instruction in the data center 20E. If the virtual machine is generated, the replica generation unit 704 transmits the generation completion notification to the transmission source of the replica preparation instruction. After the transmission of the generation completion notification, the replica generation unit 704 receives the replica data from the transmission source of the replica preparation instruction, and stores the replica data in the storage used by the virtual machine. The replica generation instruction unit 703 and the replica generation unit 704, which are included in the server 32E of Embodiment 2 correspond to the replica generation unit 352A included in the server 30A of Embodiment 1.

At the stage where the transmission of the replica from the replica source to the replica destination has not been completed, in a case where there is an access from the client device 12, the switching control unit 705 links the client device 12 to the replica source, depending on the storage location of data to be processed.

In a case where the replica is generated in the data center 20E, the update processing unit 706 transmits a difference occurring in the replica to the data center of the replica source. Although the data in the replica source is in a locked state, the access for the update by the server of the replica destination is assumed to be acceptable. In a case where the data in the replica source is stored in the data center 20E, the update processing unit 706 updates the data in the replica source, in response to an access for updating from the replica destination.

The end processing unit 707 performs the end process to delete the replica for which there is no access for a predetermined period of time. In a case where there is no access to the replica that is generated in the data center 20E, for a predetermined period, the end processing unit 707 transmits a data unlocking request, to the data center that stores the data which is the replica source of the replica. If the data unlocking request is received, the server of the data center of the replica source unlocks the data in the replica source that had been in an inaccessible so as to be in an accessible state. The end processing unit 707 transmits a difference between the data in the replica destination and the data in the replica source to the data center of the replica source. Note that with respect to the differential data, each time the process in the replica destination is executed, it is assumed that the update processing unit 706 lazy-updates the data in the replica source, but at the time of the end process, in a case where there was data that has not yet been updated, the end processing unit 707 transmits the differential data. If the update of the differential data is completed, the update completion notification is transmitted from the data center of the replica source to the end processing unit 707. The end processing unit 707 that has received the update completion notification deletes the virtual machine and the replica data that have been generated in the data center 20E. After completion of the deletion, the end processing unit 707 transmits the deletion completion notification to the data center of the replica source.

In a case of receiving the data unlocking request, the end processing unit 707 unlocks the data in the replica source in the data center 20E, which had been inaccessible.

Exemplary Flow of Information Processing Method of Embodiment 2

The flow of the information processing method of Embodiment 2 is the same in Embodiment 1. First, the data center list generation process is performed in the server. Thereafter, the replica generation necessity determination is performed in the client device. In a case of disposing the replica, thereafter, the replica generation process is performed in the server. Then, the process of the client device is performed through the connection process with the data center of the replica destination. If the process is ended, the end process is performed in the servers of the replica destination and the replica source. In contrast, in a case of not disposing the replica, the client device is connected to the data center that stores the data, and performs the process, without generating the replica. Hereinafter, the flow of each process in Embodiment 2 will be described in detail with reference to the drawings.

Data Center List Generation Process

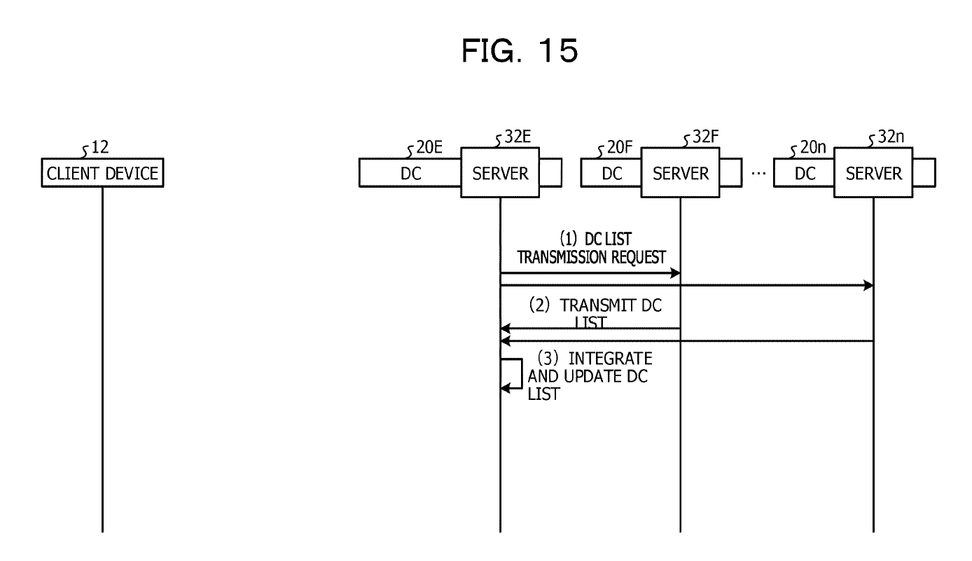

FIG. 15 is a sequence chart illustrating an exemplary flow of a data center list generation process according to Embodiment 2. As illustrated in FIG. 15, in the information processing system 2 of Embodiment 2, in each of data centers 20E to 20n (n is an arbitrary natural number), the data center list generation unit 701 generates a data center list at a predetermined timing. In the example of FIG. 15, a description will be made about a case where the data center list generation unit 701 of the data center 20E generates the data center list. First, the data center list generation unit 701 transmits a data center list transmission request for requesting the transmission of the information about the use situation of the resources in the data center, to the servers of other data centers ((1) in FIG. 15). The server (data center list generation unit) in each data center transmits the data center list that is the information about the use situations of the resources in the center, in response to the request ((2) in FIG. 15). The data center list generation unit 701 integrates the received information, and updates the information stored in the data center list storage area 602 of the data center 20E ((3) in FIG. 15). Thus, this process is completed.

Replica Generation Necessity Determination Process

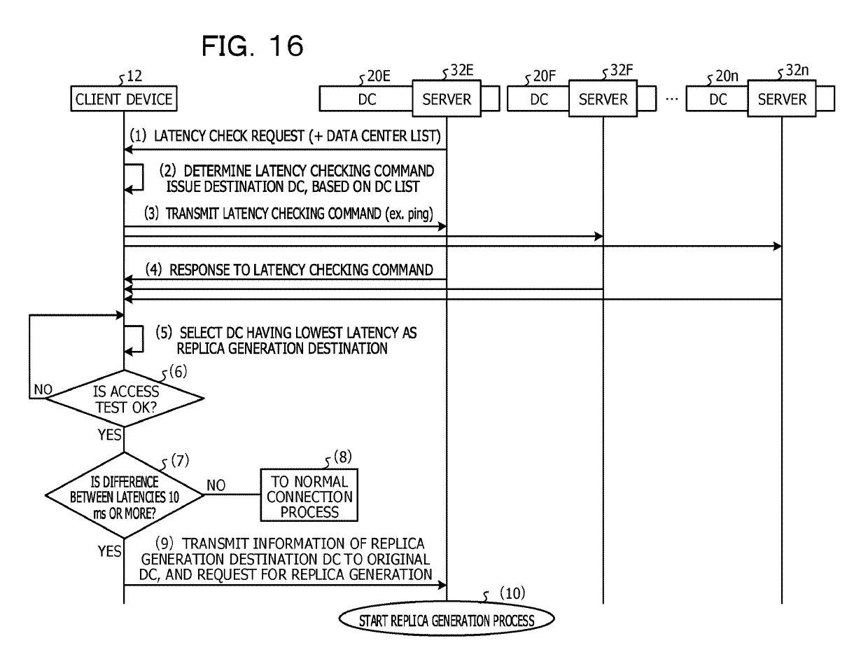

FIG. 16 is a sequence chart illustrating an exemplary flow of a replica generation necessity determination process according to Embodiment 2. In the example of FIG. 16, the data to be used by the client device 12 is stored in the server 32E of the data center 20E. Accordingly, the connection request unit 501 of the client device 12 first transmits the connection request to the data center 20E. In contrast, the latency check request transmission unit 702 of the server 32E transmits the data center list and the latency check request to the client device 12 ((1) in FIG. 16).

The latency checking unit 502 of the client device 12 that has received the latency check request selects the target data center to transmit the latency checking command, based on the data center list ((2) in FIG. 16). Then, the latency checking unit 502 transmits the latency checking command to the selected data center ((3) in FIG. 16). The latency checking unit 502 transmits, for example, ping. The latency checking unit 502 receives the response to the latency checking command ((4) in FIG. 16). If the response is received, the latency checking unit 502 calculates the latency in the communication with each data center, based on the response.

Next, the replica selection unit 503 compares the latencies calculated by the latency checking unit 502, and selects the data center having the lowest latency as the replica destination ((5) in FIG. 16). Next, the replica selection unit 503 performs an access test on the selected data center ((6) in FIG. 16). As a result of the access test, in a case where it is determined as being inaccessible (No in (6) of FIG. 16), the replica selection unit 503 selects the data center having the second lowest latency and repeats the access test. In contrast, in a case where it is determined as being accessible (Yes in (6) of FIG. 16), the replica selection unit 503 compares the latency of the selected data center with the latency of the data center 20E. The replica selection unit 503 determines whether or not the difference between the latencies is a predetermined value or more ((7) in FIG. 16).

In the example of FIG. 16, in (7), it is assumed that the replica selection unit 503 determines whether or not the difference between the latencies is 10 ms or more. That is because the influence of the processing delay due to the time used to generate the replica is considered to be larger than the influence due to a decrease in the latency, in a case where the difference between latencies is small. For example, if the difference in latencies is in the same digit unit, the cost used for generating a replica is considered to be high. For example, since the latency of the data center 20E is 13 ms, and the latency of the selected data center is 11 ms, the difference is assumed to be 2 ms. In this case, the cost used for replica generation is considered to be larger than the influence due to replica generation. Therefore, in a case where the difference between latencies is in the same digit unit, the replica is not generated, and the original data center is used. In contrast, in a case where the difference between latencies is larger than one digit unit, the influence due to replica generation is considered to be larger than the cost. For example, since the latency of the data center 20E is 23 ms, and the latency of the selected data center is 11 ms, the difference is assumed to be 12 ms. In this case, the influence due to replica generation is considered to be larger than the cost used for replica generation. Therefore, the replica generation is performed.

In a case where the difference between the latencies is determined to be less than 10 ms (No in (7) of FIG. 16), the replica selection unit 503 determines that the replica generation is not to be performed. Then, the replica generation instruction unit 504 that has received the notification from the replica selection unit 503 transmits a normal connection instruction to the server 32E and executes the normal connection process ((8) in FIG. 16). In contrast, in a case where the difference between the latencies is determined to be 10 ms or more (Yes in (7) of FIG. 16), the replica selection unit 503 determines that the replica generation is to be performed. The replica selection unit 503 notifies the replica generation instruction unit 504 that the replica is to be generated in the selected data center. The replica generation instruction unit 504 transmits the replica generation instruction to the data center 20E ((9) in FIG. 16). The replica generation instruction includes information of the replica destination data center that the replica selection unit 503 has selected. The server 32E receives the replica generation instruction, and starts the replica generation process ((10) in FIG. 16).

Replica Generation Process

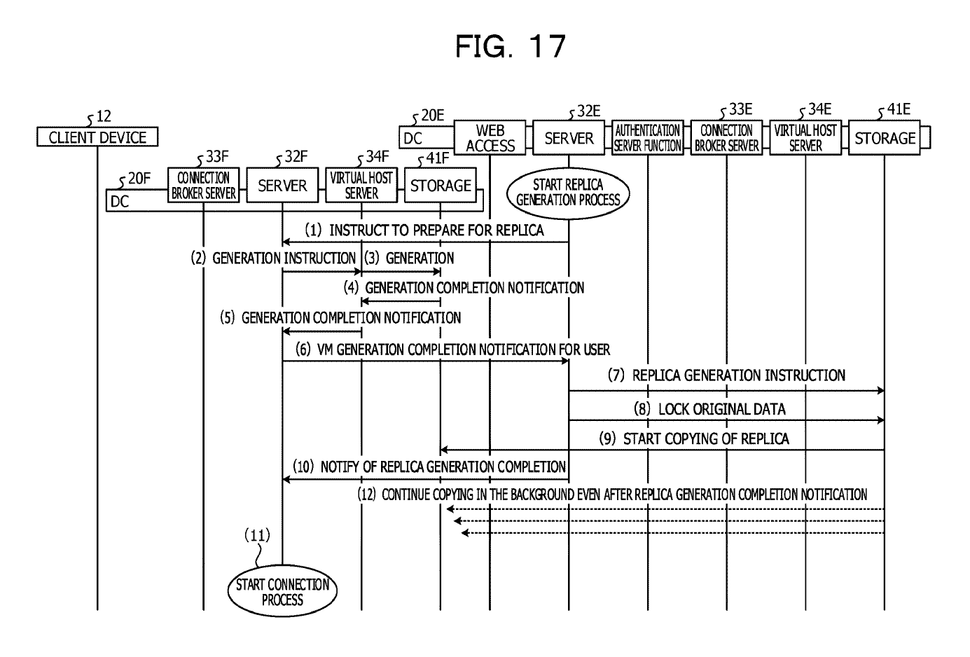

FIG. 17 is a sequence chart illustrating an exemplary flow of a replica generation process according to Embodiment 2. After the replica generation necessity determination process illustrated in FIG. 16, the replica generation process is started.

First, as the result of the replica generation necessity determination process, the replica generation instruction is transmitted from the client device 12 to the server 32E. If the replica generation instruction is received, the replica generation instruction unit 703 of the server 32E transmits a replica preparation instruction instructing the replica destination data center to generate a virtual machine, based on the information included in the replica generation instruction ((1) in FIG. 17). Here, 20F is assumed to be selected as a replica destination data center.

The replica generation unit 704 of the server 32F of the data center 20F that has received the replica preparation instruction generates a virtual machine of the capacity that is specified by the replica preparation instruction, in data center 20F. The replica generation unit 704 instructs, for example, the virtual host server 34F in the data center 20F to generate a virtual machine for the user of the client device 12 ((2) in FIG. 17). The virtual host server 34F generates the virtual machine by using the storage 41F ((3) in FIG. 17), and if a generation completion notification is received ((4) in FIG. 17), the virtual host server 34F transmits the generation completion notification to the replica generation unit 704 ((5) in FIG. 17). Here, a description has been made assuming that the server 32F, the virtual host server 34F, and the storage 41F are respectively disposed in separate servers, but the virtual host and the storage may be disposed in the server 32F.

The replica generation unit 704 of the replica destination that has received the generation completion notification of the virtual machine transmits the virtual machine generation completion notification for the user to the replica generation instruction unit 703 of the server 32E which is the replica source ((6) in FIG. 17). Next, the replica generation instruction unit 703 of the replica source instructs the storage 41E in the data center 20E to generate a replica ((7) in FIG. 17). The replica generation instruction unit 703 of the replica source locks the data in the replica source so as to be in an inaccessible state such that other devices do not access and change the data in the replica source ((8) in FIG. 17).

The replica generation instruction unit 703 of the replica source sequentially transmits the replica data to the storage 41F of the data center 20F which is the replica destination, with the progress of the replica generation ((9) in FIG. 17). The replica generation instruction unit 703 of the replica source, for example, first starts remote-copying of the user profile disk. At this time, the replica generation instruction unit 703 preferentially copies the file having a high access frequency. In addition, the replica generation instruction unit 703 adjusts the order of transmission of data such that streaming data is to be copied later than the other data.

After the start of the transmission of the replica data, the replica generation instruction unit 703 transmits the replica generation completion notification to the server 32F ((10) in FIG. 17). The replica generation completion notification is transmitted before the transmission of the replica data is completed. Thereafter, the replica destination that has received the replica generation completion notification starts a connection process ((11) in FIG. 17). Even after the transmission of the replica generation completion notification, the replica generation instruction unit 703 continues copying of the replica data in the background ((12) in FIG. 17). Thus, the replica generation process is ended.

Connection Process

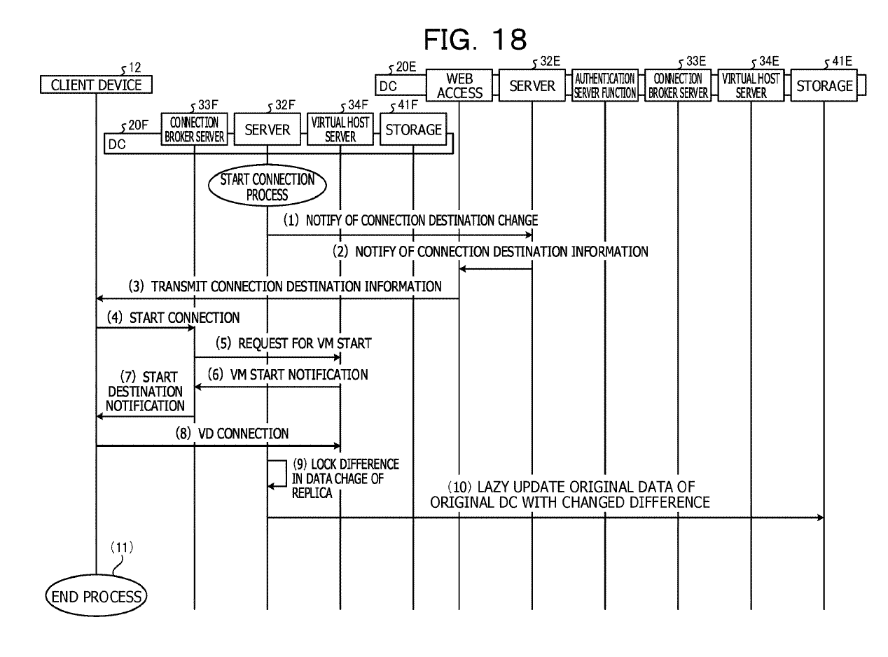

FIG. 18 is a sequence chart illustrating an exemplary flow of a connection process according to Embodiment 2. The replica generation unit 704 of the server 32F of the replica destination that has received the replica generation completion notification from the replica generation instruction unit 703 of the server 32E of the replica source notifies the replica generation instruction unit 703 of a connection destination change ((1) in FIG. 18). The replica generation unit 704 transmits, for example, the connection destination information of the virtual machine that is generated for the user, to the replica generation instruction unit 703. The replica generation instruction unit 703 of the server 32E transmits the connection destination information to the client device 12, based on the received information ((2) and (3) in FIG. 18). In the example of FIG. 18, since each data center has a Web access function and an authentication server function, the connection destination information is once passed to the Web access function. Thereafter, the connection destination information is transmitted to the client device 12 from the Web access function.

If the connection destination information is received, the connection request unit 501 of the client device 12 accesses the connection destination that is specified by the connection destination information ((4) in FIG. 18). In Embodiment 2, the connection broker server characterizes a route for access for VDI. The connection broker server 33F makes a request to the virtual host server 34F so as to start the virtual machine that is the connection destination, based on the connection destination information transmitted from the client device 12 ((5) in FIG. 18). The virtual host server 34F starts the virtual machine in response to the start request, and transmits a start notification to the connection broker server 33F ((6) in FIG. 18). The connection broker server 33F notifies the client device 12 of the start destination, in response to the start notification ((7) in FIG. 18). The client device 12 establishes VDI connection with the virtual host server 34F, in response to the start destination notification ((8) in FIG. 18). Then, the client device 12 executes information processing by using the virtual machine. A difference generated in the replica data by the information processing is transmitted from the virtual host server 34F to the server 32F, and the log of the difference generated by the update processing unit 706 of the server 32F is accumulated ((9) in FIG. 18). The update processing unit 706 substantially lazy-updates the storage 41E of the data center 20E of the replica source with the generated difference ((10) in FIG. 18). Thus, the connection process of Embodiment 2 is ended. Thereafter, the replica is deleted, and the end process for ending the process using the replica is executed ((11) in FIG. 18).

End Process

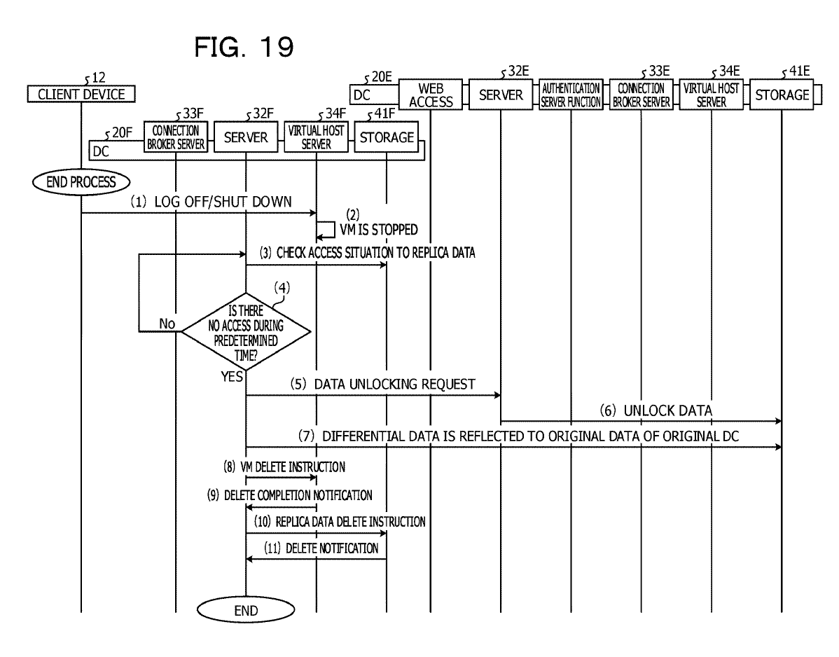

FIG. 19 is a sequence chart illustrating an exemplary flow of an end process according to Embodiment 2. If the process using the replica is completed, the user of the client device 12 logs off from the client device 12, and shuts down the client device 12 ((1) in FIG. 19). Since the process by the client device 12 is ended, the process of the virtual machine that is generated in the virtual host server 34F is also ended ((2) in FIG. 19). The end processing unit 707 of the server 32F of replica destination checks the presence or absence of access to the replica, for each predetermined period ((3) in FIG. 19). In a case where there is an access to the replica during a predetermined time (No in (4) of FIG. 19), the end processing unit 707 is again on standby for a predetermined time, and repeats the process. Meanwhile, in a case where it is determined that there is no access to the replica during a predetermined time (Yes in (4) of FIG. 19), the end processing unit 707 transmits a data unlocking request to the server 32E of the replica source ((5) in FIG. 19). If the data unlocking request is received, the end processing unit 707 of the server 32E unlocks the data in the replica source ((6) in FIG. 19). Then, differential data is transmitted by the end processing unit 707 of the server 32F, and the data in the replica source is updated ((7) in FIG. 19).

The end processing unit 707 of the replica destination instructs the virtual host server 34F to delete the virtual machine that is generated in the replica generation process ((8) in FIG. 19). The virtual host server 34F deletes the virtual machine, and transmits a delete completion notification to the end processing unit 707 ((9) in FIG. 19). In addition, the end processing unit 707 instructs the storage 41F storing the replica data to delete the replica data ((10) in FIG. 19). The storage 41F deletes the replica data, and transmits the deletion notification to the end processing unit 707 ((11) in FIG. 19). Thus, the end process according to Embodiment 2 is ended.

Normal Connection Process

In Embodiment 2, in a case where there is no replica generation instruction, it is assumed that the replica generation instruction unit 504 transmits a normal connection instruction to the server 32E. In this case, in the server 32E, the latency check request transmission unit 702 that has received the normal connection instructions transmits connection destination information that has been held, to the client device 12, using the Web access function. Then, the client device 12 performs a VDI connection with the access destination in the data center 20E by using the connection destination information.

### Modification Example 1

### Generation of Data Center List

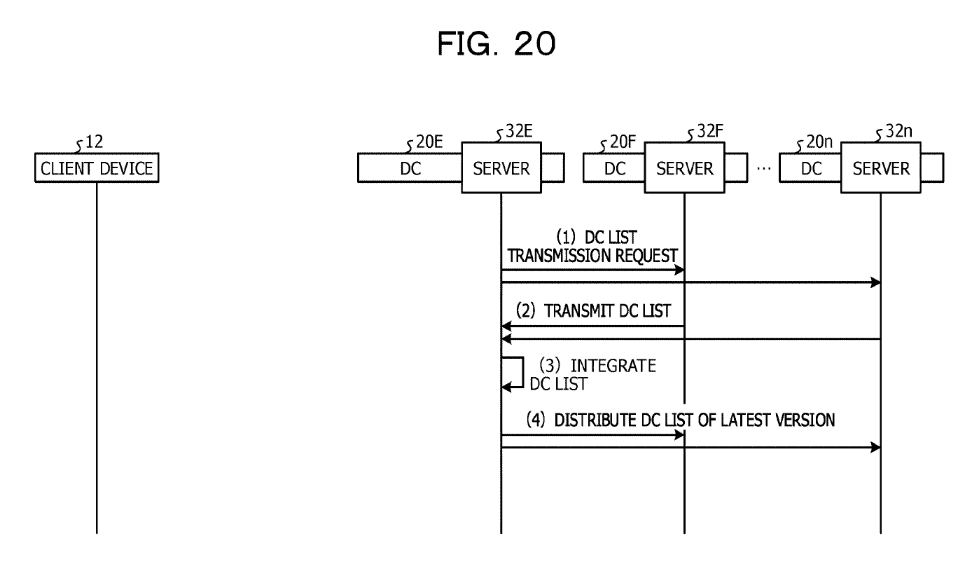

In the above-mentioned Embodiment 2, the server of each data center is intended to generate a data center list. Without being limited thereto, the present disclosure may be configured such that one data center of the plurality of data centers generates a data center list and distributes the generated data center list to other data centers. The flow of a process in the case of such a configuration is illustrated in FIG. 20. FIG. 20 is a sequence chart illustrating an exemplary flow of a data center list generation and distribution process according to Modification Example 1 of Embodiment 2.

As illustrated in FIG. 20, in Modification Example 1, the data center 20E is set in advance as a data center that generates a data center list. The server 32E of the data center 20E transmits a data center list transmission request to the servers 32F to 32n of other data centers 20F to 20n, at a predetermined timing ((1) in FIG. 20). For example, when it is a predetermined time every day, the server 32E transmits the data center list transmission request. The servers 32E to 32n of the respective data centers 20F to 20n transmit data center lists in response to the request ((2) in FIG. 20). The data center list generation unit 701 of the server 32E of the data center 20E integrates the data center lists that are transmitted from the servers 32E to 32n of the respective data centers 20F to 20n ((3) in FIG. 20). Then, the data center list generation unit 701 of the server 32E of the data center 20E distributes the data center list of the latest version that is obtained by the integration to other data centers ((4) in FIG. 20).

In the case of such a configuration, data centers other than the data center 20E may collect and accumulate data related to the processing situation in the data centers. In addition, since a regularly updated data center list is distributed from the data center 20E, it is possible to share a unified data center list among the data centers.

### Modification Example 2

### Replica Destination Selection by Server

In the above-mentioned Embodiment 2, the client device 12 is intended to select the data center of the replica destination. Without being limited thereto, the present disclosure may be configured such that data centers can select a data center of the replica destination.

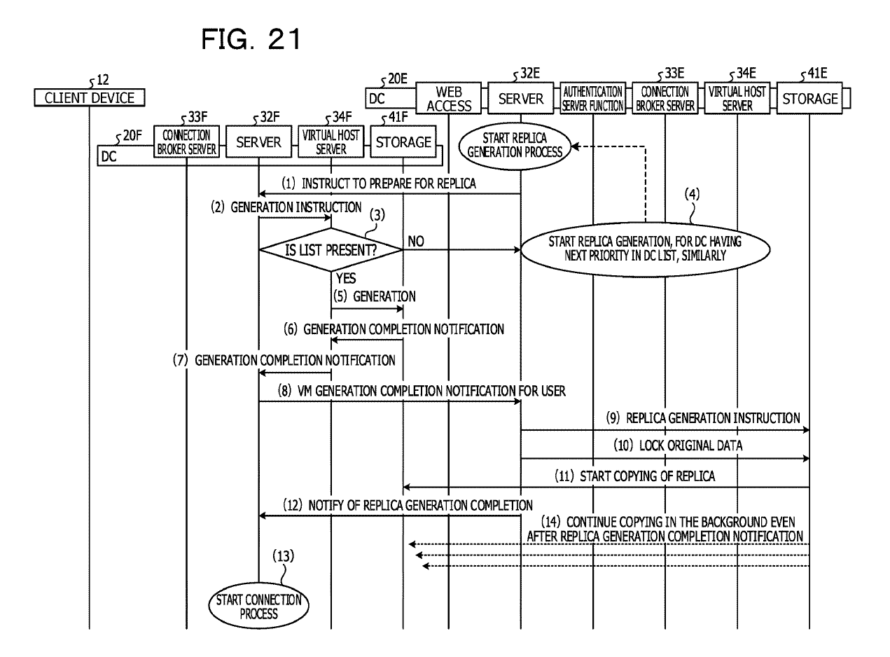

FIG. 21 is a sequence chart illustrating an exemplary flow of a replica destination changing process according to Modification Example 2. The process illustrated in FIG. 21 can be executed instead of the replica generation process illustrated in FIG. 17.

As a premise of the process of FIG. 21, the replica selection unit 503 of the client device 12 performs the following processes. The replica selection unit 503 prioritizes each data center as a replica destination, based on the information that is stored in the latency check result storage area 401 and the information that is stored in the data center list storage area 402. First, the replica selection unit 503 sorts the data centers in an ascending order of the length of the latency. The rank of a data center for which the rank of the latency is high, but the current time corresponds to the date and time which is stored as “busy situation” is moved to the lowest. Further, it is also possible to include the information about the resource usage for each time zone of each data center in the data center list. Then, the rank of the data center having a low “usage” of the current time is raised by a predetermined rank. In this manner, the replica selection unit 503 determines the priority for selecting a data center, in accordance with the usage and the busy status of each data center, in addition to the latency, and stores the determined priority in the data center list storage area 402.

When receiving the notification that the replica generation instruction is to be made, from the replica selection unit 503, the replica generation instruction unit 504 of the client device 12 reads out the data center list that is stored in the data center list storage area 402 and the priorities. When transmitting the replica generation instruction to the server 32E, the replica generation instruction unit 504 also transmits the data center list including the priorities.

As the premise of the above-described process, the replica destination change process of FIG. 21 is to be executed after the replica generation instruction is transmitted from the client device 12 to the server 32E, as the result of the replica generation necessity determination process.

First, similarly to the replica generation process illustrated in FIG. 17, the replica generation instruction unit 703 of the server 32E receives a replica generation instruction, and transmits the replica preparation instruction to the replica destination data center ((1) in FIG. 21). The replica generation unit 704 of the server 32F of the replica destination transmits a generation instruction to the virtual host server 34F in order to generate the virtual machine in the data center 20F ((2) in FIG. 21). The processes up to here are the same as (1) and (2) in FIG. 17. Next, the virtual host server 34F determines whether or not it is possible to perform the assignment of the desktop to the user, in response to the generation instruction. The virtual host server 34F, for example, determines whether or not there is a resource to perform the assignment of the desktop to the user ((3) in FIG. 21). If it is determined that there is no resource to perform the assignment of the desktop (No in (3) of FIG. 21), the virtual host server 34F notifies the replica generation unit 704 of the server 32F that the replica generation is not possible. If the notification is received, the replica generation unit 704 notifies the replica generation instruction unit 703 of the replica source that the replica generation is not possible. In contrast, if it is determined that there is the resource (Yes in (3) of FIG. 21), the virtual host server 34F generates a virtual machine ((5) in FIG. 21). The processes from (5) to (14) in FIG. 21 are the same as the processes from (3) to (12) in FIG. 17.

It is determined that there is no resource in (3) in FIG. 21, and the replica generation instruction unit 703 that has received the notification selects a data center having the priority next to the priority of the data center 20F, with reference to the replica generation instruction and the received data center list ((4) in FIG. 21). The replica generation instruction unit 703 transmits again a replica generation preparation instruction to the server of the selected data center, and repeats the process.

With this configuration, in a case where inconvenience occurs after the client device 12 selects a data center of the replica destination, the data center can again select the replica destination and continue processing.

### Modification Example 3

### Re-Connection Process after Replica Generation

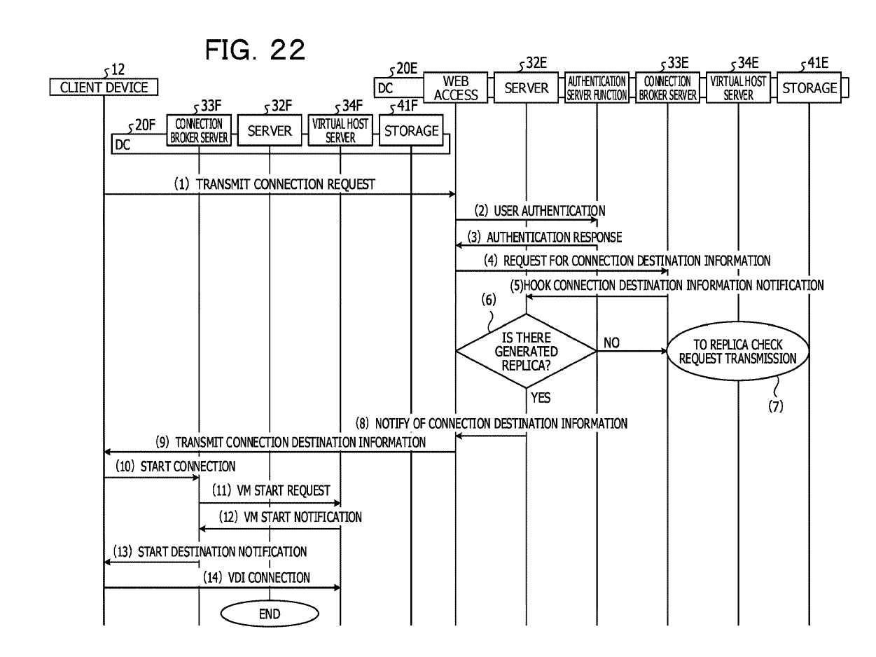

In Embodiment 2, it is assumed that the end process is executed by deleting the replica, if there is no access due to the shutdown by the client device 12 for a predetermined time after the generation of the replica. In addition, a configuration is possible in which the client device 12 that ends the process and performs shutdown after the generation of the replica can again assess the replica. FIG. 22 is a sequence chart illustrating an exemplary flow of a re-connection process after replica generation according to Modification Example 3 of Embodiment 2.

As a premise of the process of FIG. 22, it is assumed that the server of Modification Example 3 stores the presence or absence of the generation of the replica of the data in the data center and the information about the user who uses the data and the replica in association with each other.

First, the connection request unit 501 of the client device 12 transmits a connection request to the data center 20E of the replica source, in order to use the data stored in the information processing system 2 ((1) in FIG. 22). In the data center 20E, the connection request is first received by the Web access function in the data center 20E, and the user authentication is performed by the authentication server function ((2) in FIG. 22). After the user authentication is successful, an authentication response is transmitted to the Web access function from the authentication server function ((3) in FIG. 22). The Web access function next makes a request for the connection destination information to the connection broker server 33E, in order to notify the client device 12 of the connection destination ((4) in FIG. 22). The connection broker server 33E transmits the connection destination information in response to the request. The latency check request transmission unit 702 of the server 32E does not pass the transmitted connection destination information to the Web access function and holds it ((5) in FIG. 22, “Hook the connection destination information notification”). The latency check request transmission unit 702 determines whether or not the replica is generated for the data of the access destination corresponding to the connection destination information, with reference to the stored information ((6) in FIG. 22). In a case where it is determined that there is no generated replica (No in (6) of FIG. 22), the latency check request transmission unit 702 transmits the latency check request to the client device 12 ((7) in FIG. 22). In contrast, in a case where it is determined that there is a generated replica (Yes in (6) of FIG. 22), the latency check request transmission unit 702 does not transmit the latency check request, and transmits the connection destination information on the replica to the client device 12 ((8) and (9) in FIG. 22). The processes from (8) to (14) of FIG. 22 are the same as the processes from (2) to (8) of FIG. 18.

With this configuration, once the replica is generated, in a case of using again a replica, it is possible to realize a smooth connection to the replica.

### Effects of Embodiment 2

In the information processing system according to Embodiment 2 configured as described above, the information processing device (client device) includes the selection unit and the instruction unit. The selection unit selects one data center out of the plurality of data centers, based on the latency in the communication with each of the plurality of data centers. Then, the instruction unit transmits an instruction to generate the replica of the predetermined type of data in the one selected data center, to the data center storing a predetermined type of data, among the plurality of data centers. Therefore, it is possible to suppress an increase in latency. For example, in a case where the user accesses the information stored in the cloud server by using the information processing device, it is possible to suppress an increase in the latency due to the change of the point to be accessed. Further, it is possible to improve the processing speed in a case of being viewed from the user, by adjusting the storage location of the data based on the latency. Accordingly, in a case where the user uses VDI or the like, even at locations remote from the server of the replica source, it is possible to realize a rapid process, without feeling influence of the distance. In addition, the information processing system according to Embodiment 2 has the same effects as the information processing system according to Embodiment 1.

Further, the information processing system according to Embodiment 2 is applied to the process using a VDI. In a case of using the VDI, each data center holds the information about the basic virtual machine. Therefore, if the replica of the difference information of the client device alone is copied, there is no problem in processing. The difference information includes user information, registry setting and document such as my document. Therefore, a time used for the process of generating a replica and copying the replica to other servers as in Embodiment 2 does not significantly affect the overall process.

Each component of each device is functionally and conceptually illustrated, and does not have to be physically configured as illustrated. In other words, the specific state where respective devices are distributed and integrated is not limited to those illustrated, and it is possible to distribute and integrate a whole or parts functionally or physically into arbitrary units, depending on various loads, use situation, or the like. For example, the respective processing units of the latency checking unit 502, the replica selection unit 503, and the replica generation instruction unit 504 included in the client device 12 may be integrated as appropriate. In addition, the processes of each processing unit may be separated into a plurality of processing units as appropriate. With respect to the respective processing functions performed by each processing unit, the whole or an arbitrary part is realized by the CPU or a program that is analyzed and executed by the CPU, or can be realized as hardware by a wired logic.

Information Processing Program

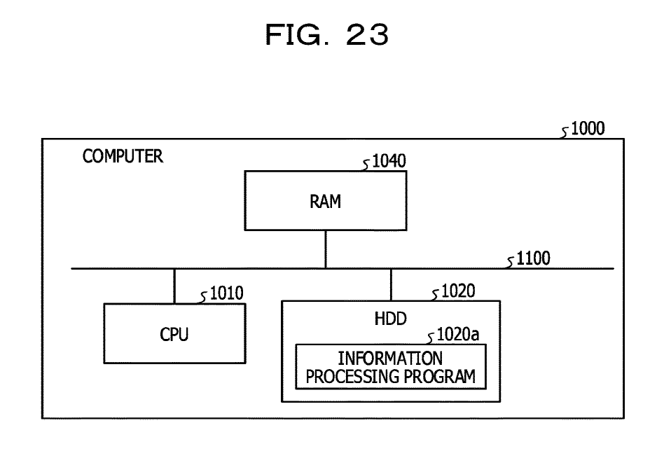

Further, various processes described in the above embodiment can also be realized by a computer system such as a personal computer or a workstation executing a prepared program. Therefore, hereinafter, a description will be given of an example of a computer system that executes a program having the same functions as those in the above embodiment. FIG. 23 is a diagram illustrating a computer that executes an information processing program.

As illustrated in FIG. 23, a computer 1000 includes a central processing unit (CPU) 1010, a hard disk drive (HDD) 1020, and a random access memory (RAM) 1040. The respective units of the CPU 1010, the HDD 1020, and the RAM 1040 are connected through a bus 1100.

An information processing program 1020a having the same function as each processing unit included in the client device 12 and each processing unit included in the server 32E is stored in advance in the HDD 1020. It is to be noted that the information processing program 1020a may be separated as appropriate.

In addition, the HDD 1020 stores various types of information. For example, the HDD 1020 stores various types of information that are used for OS and a production plan.

Then, the CPU 1010 executes the same operations as those of each processing unit of the embodiment by reading and executing the information processing program 1020a from the HDD 1020.

Note that the information processing program 1020a described above does not have to be stored in the HDD 1020 from the beginning.

For example, a program may be stored in a portable physical media such as a flexible disk (FD), a CD-ROM, a DVD disk, a magneto-optical disk, and an IC card, which are inserted into the computer 1000. Then, the computer 1000 may read and execute the program from these.

In addition, a program may be stored in “another computer (or server)” connected to the computer 1000 through a public line, the Internet, a LAN, and a WAN. Then, the computer 1000 may read and execute the program from these.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method that is executed by an information processing device which communicates with a plurality of data centers through a network, the information processing method comprising:
transmitting a first request to each of the plurality of data centers;
receiving a first response to the first request, from each of the plurality of data centers;
acquiring latency in communication through the network, for each of the plurality of data centers, based on time from transmission of the first request to reception of the first response;
selecting a first data center from among the plurality of data centers, based on the latency of each of the plurality of data centers; and
transmitting a second request for providing a replica of data addressed to the first data center, to a second data center among the plurality of data centers, the second data center storing data regarding the information processing device.

2. The information processing method according to claim 1, further comprising:
acquiring information about a use situation of the plurality of data centers, from at least one of the plurality of data centers.

3. The information processing method according to claim 2, wherein the first data center is selected based on the latency and the use situation.

4. The information processing method according to claim 1, wherein the first data center is a data center having the lowest latency from among the plurality of data centers.

5. The information processing method according to claim 1, further comprising:
determining whether or not a difference between a first latency of the first data center and a second latency of the second data center is a threshold or more; and
transmitting the second request to the second data center when the difference is the threshold or more.

6. An information processing system which includes a plurality of servers which are respectively disposed in a plurality of data centers, and an information processing device which communicates with the plurality of servers through a network,
the information processing device comprising:
a first memory; and
a first processor coupled to the first memory and configured to:
transmit a first request to each of the plurality of data centers,
receive a first response to the first request, from each of the plurality of data centers,
acquire latency in communication through the network, for each of the plurality of data centers, based on time from transmission of the first request to reception of the first response,
select a first data center from among the plurality of data centers, based on the latency of each of the plurality of data centers, and
transmit a second request for providing a replica of data addressed to the first data center, to a second data center among the plurality of data centers, the second data center storing data regarding the information processing device, and
the plurality of servers comprising respectively:
a second memory; and
a second processor coupled to the second memory and configured to:
transmit the first response, in a case of receiving the first request, and
generate the replica and provide the replica to the first data center that is designated by the second request, in a case of receiving the second request.

7. The information processing system according to claim 6, wherein the second processor in each of the plurality of servers is configured to provide the replica to the first data center, in order from a file having a high access frequency, in a case of receiving the second request.

8. The information processing system according to claim 6, wherein the second processor in each of the plurality of servers is configured to:
transmit information for connection to the first data center, to the information processing device, before provision of the replica is completed, in a case of receiving the second request, and
continue providing the replica to the first data center, in the background, after the information processing device starts connection to the first data center.

9. The information processing system according to claim 6, wherein the second processor in each of the plurality of servers is configured to:
acquire information about the use situations of other data centers, from other data centers,
generate a data center list, based on the use situations of the plurality of data centers, and
transmit the data center list to the information processing device.

10. The information processing system according to claim 9, wherein the second processor in each of the plurality of servers is configured to select data centers other than the first data center, based on the data center list, among the plurality of data centers, as new provision destinations of the replica, in a case of receiving the second request, and when it is determined that the replica is not to be provided to the first data center that is designated by the second request.

11. The information processing system according to claim 6, wherein the second processor in each of the plurality of servers is configured to delete the replica when there is no access to the replica for a predetermined period after the replica is generated.

12. An information processing device which communicates with a plurality of data centers through a network, the information processing device comprising:
a memory; and
a processor coupled to the memory and configured to:
transmit a first request to each of the plurality of data centers,
receive a first response to the first request, from each of the plurality of data centers,
acquire latency in communication through the network, for each of the plurality of data centers, based on time from transmission of the first request to reception of the first response,
select a first data center from among the plurality of data centers, based on the latency of each of the plurality of data centers, and
transmit a second request for providing a replica of data addressed to the first data center, to a second data center among the plurality of data centers, the second data center storing data regarding the information processing device.

13. The information processing device according to claim 12, wherein the processor is configured to acquire information about a use situation of the plurality of data centers, from at least one of the plurality of data centers.

14. The information processing device according to claim 13, wherein the first data center is selected based on the latency and the use situation.

15. The information processing device according to claim 12, wherein the first data center is a data center having the lowest latency.

16. The information processing device according to claim 12, wherein the processor is configured to:
determine whether or not a difference between a first latency of the first data center and a second latency of the second data center is a threshold or more, and
transmit the second request to the second data center when the difference is the threshold or more.
